(19) United States
(12) Patent Application Publication
(10) Pub. No.: US 2004/0173921 A1
(43) Pub. Date: Sep. 9, 2004

(54) Electron beam depicting method, production method of mother die, mother die, production method of metallic mold, metallic mold, optical element and electron beam depicting apparatus

(75) Inventors: Kazumi Furuta, Tokyo (JP); Osamu Masuda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/789,310

(22) Filed: Feb. 26, 2004

(30) Foreign Application Priority Data
Mar. 7, 2003 (JP) JP2003-061918
Mar. 11, 2003 (JP) JP2003-064444

(51) Int. Cl. B29D 11/00

(52) U.S. Cl. 264/1.31; 264/485; 264/40.1; 264/2.5; 205/70; 425/808; 425/174.4; 425/140

(57) ABSTRACT

There is described a method for depicting a predetermined diffraction structure on a substrate by scanning an electron beam onto the substrate. The method includes the steps of: measuring a contour of the substrate so as to detect height errors in surface heights in comparison with specified values of a surface height distribution of the substrate; adjusting a depicting mode for depicting each of diffraction gratings, which constitute the predetermined diffraction structure, in response to the height errors detected in the measuring step, so as to compensate for a phase change of diffracted light caused by each of the height errors corresponding to each of the diffraction gratings; and depicting each of the diffraction gratings by scanning the electron beam onto the substrate, according to the depicting mode adjusted in the adjusting step. The depicting mode represents each spacing between the diffraction gratings or a dose of the electron beam.

### BACKGROUND OF THE INVENTION

The present invention relates to a depicting technology by an electron beam, and particularly to a depicting technology by which, onto a base material which is a depicted object, a predetermined pattern, for example, a diffraction pattern corresponding to an optical element is depicted.

Conventionally, a CD and a DVD are widely used as an information recording medium, and for a precision equipment such as a reading apparatus by which the information is read from these recording media, many optical elements are used.

Recently, a specification or performance required for these optical elements is improved, and particularly, in a pick-up lens for a recording medium such as the DVD, to an increase of a recording density, it is required that a more accurate diffraction structure is formed. Specifically, a processing accuracy in a scale smaller than a wavelength of the light, for example, sub-10 nm scale, is required.

Hereupon, these optical elements, for example, in an optical lens, from a viewpoint of a cost reduction and size reduction, resin optical lenses are used more than a glass optical lens, and such a resin optical lens is produced by a common injection molding.

Accordingly, for example, when the optical element having the diffraction structure on the optical function surface is produced, it is necessary that the surface to give such a diffraction structure be previously formed on a molding die to injection-mold this optical element.

Up to now, the molding die is processed by a common engineering, for instance, a cutting bite of processing engineering, however, when the fine shape such as a such diffraction structure is to be formed, the processing accuracy is poor, and there is a limit in the strength or life of bite, and it is difficult that the accurate processing in the sub-micron order or in the level more accurate than that is conducted.

Accordingly, a following trial is conducted: when a fine shape such as a such diffraction structure is depicted on a base material which becomes a mother die, and this is development-processed, a fine structure is formed and a mother die is obtained, and by using this mother die, when the electrocasting is conducted, the fine shape is transfer-formed onto a metallic mold, and a molding die is obtained (for example, refer to Patent Document 1).

[Patent Document 1]

Tokkai 2002-333722

However, in such a production process, in contrast to a fact that conventionally, only a cutting processing process is necessary, processes in which the cutting processing process by which the raw material is cut and the base material is obtained, a resist film forming process to form a resist film on the base material, a depicting process to depict the fine shape on the resist film on the base material, a developing process to develop this, an etching process by which this is etched and the mother die is obtained, and an electrocasting process by which the electrocasting is conducted by using the mother die, are necessary, and the number of processes are increased from 1 to 6.

However, when the number of processes is increased in this manner, the processing errors in each process are accumulated, and that total errors are as follows.

Total errors=sqrt(p1²+p2²+p3³+ . . . +p6²+ . . . )

(pn: error in n-process)

In this connection, when a case in which the number of process is 1 is compared to a case in which the number of processes are 6, in the case in which the number of processes is 6, in order to keep the total error which is about the same degree as the case in which the number of process is 1, the processing accuracy required in each process is ½-1/3 of the conventional one.

Hereupon, in the case of the optical element such as an OD lens, in the depicting process, because the processing accuracy in the level within several 10 s nm to the designed value is required, it is very difficult target to realize the more accuracy.

Accordingly, in order to solve the accumulation of the processing error by the increase of the number of processes, in any one of processes, it is necessary that the correction of the error is conducted.

### SUMMARY OF THE INVENTION

To overcome the abovementioned drawbacks in conventional electron beam depicting methods and apparatus, it is an object of the present invention to provide an electron beam depicting method by which the correction to solve the processing error accumulated in other processes is conducted, and the diffraction structure by which a predetermined optical performance can be obtained, can be depicted.

Accordingly, to overcome the cited shortcomings, the abovementioned object of the present invention can be attained by electron beam depicting methods and apparatus described as follow.

(1) A method for depicting a predetermined diffraction structure on a substrate by scanning an electron beam onto the substrate, serving as a base material, comprising the steps of: measuring a contour of the substrate so as to detect height errors in surface heights in comparison with specified values of a surface height distribution of the substrate; adjusting a depicting mode for depicting each of diffraction gratings, which constitute the predetermined diffraction structure, in response to the height errors detected in the measuring step, so as to compensate for a phase change of diffracted light caused by each of the height errors corresponding to each of the diffraction gratings; and depicting each of the diffraction gratings by scanning the electron beam onto the substrate, according to the depicting mode adjusted in the adjusting step.

(2) The method of item 1, wherein the depicting mode represents each spacing between the diffraction gratings.

(3) The method of item 2, wherein, in the adjusting step, a space between the diffraction gratings is adjusted to a small value when a concerned error, being one of the height errors, is positive, while a space between the diffraction gratings is adjusted to a large value when a concerned error, being one of the height errors, is negative.

(4) The method of item 1, wherein the depicting mode represents a dose of the electron beam for depicting each of the diffraction gratings.

(5) The method of item 4, wherein, in the adjusting step, when a concerned error being one of the height errors is positive, the dose of the electron beam is adjusted to a large value, to such an extent that it is equivalent to an amount for depicting the concerned error, while, when a concerned error being one of the height errors is negative, the dose of the electron beam is adjusted to a small value, to such an extent that it is equivalent to an amount for depicting the concerned error.

(6) The method of item 1, wherein the contour of the substrate, onto which the diffraction gratings are depicted, is a carved surface.

(7) The method of item 1, further comprising the step of: measuring a thickness of a resist film formed on the substrate so as to detect thickness errors of the resist film in comparison with specified values of a film thickness distribution of the resist film; wherein, in the adjusting step, the phase change of the diffracted light, caused by each of the height errors and each of the thickness errors corresponding to each of the diffraction gratings, is compensated for, in response to the height errors and the thickness errors detected in the measuring steps.

(8) A method for depicting a predetermined diffraction structure on a substrate by scanning an electron beam onto the substrate, comprising the steps of: measuring a thickness of a resist film formed on the substrate so as to detect thickness errors of the resist film in comparison with specified values of a film thickness distribution of the resist film; adjusting a depicting mode for depicting each of diffraction gratings, which constitute the predetermined diffraction structure, in response to the thickness errors detected in the measuring step, so as to compensate for a phase change of diffracted light caused by each of the thickness errors corresponding to each of the diffraction gratings; and depicting each of the diffraction gratings by scanning the electron beam onto the resist film, according to the depicting mode adjusted in the adjusting step.

(9) The method of item 8, wherein the depicting mode represents each spacing between the diffraction gratings.

(10) The method of item 9, wherein, in the adjusting step, a space between the diffraction gratings is adjusted to a small value when a concerned error, being one of the thickness errors, is positive, while a space between the diffraction gratings is adjusted to a large value when a concerned error, being one of the thickness errors, is negative.

(11) The method of item 8, wherein the depicting mode represents a dose of the electron beam for depicting each of the diffraction gratings.

(12) The method of item 11, wherein, in the adjusting step, when a concerned error being one of the thickness errors is positive, the dose of the electron beam is adjusted to a large value, to such an extent that it is equivalent to an amount for depicting the concerned error, while, when a concerned error being one of the thickness errors is negative, the dose of the electron beam is adjusted to a small value, to such an extent that it is equivalent to an amount for depicting the concerned error.

(13) The method of item 8, wherein a contour of the substrate, onto which the diffraction gratings are depicted, is a carved surface.

(14) A method for manufacturing a mother die of a mold utilized for molding an optical element having a predetermined diffraction structure, comprising the steps of: measuring a contour of a substrate, on which the predetermined diffraction structure is depicted, and/or a thickness of a resist film formed on the substrate, so as to detect height errors in surface heights in comparison with specified values of a surface height distribution of the substrate and/or thickness errors of the resist film in comparison with specified values of a film thickness distribution of the resist film; adjusting a depicting mode for depicting each of diffraction gratings, which constitute the predetermined diffraction structure, in response to the height errors and/or the thickness errors detected in the measuring step, so as to compensate for a phase change of diffracted light caused by each of the height errors and/or each of the thickness errors corresponding to each of the diffraction gratings; and depicting each of the diffraction gratings by scanning an electron beam onto the resist film formed on the substrate, according to the depicting mode adjusted in the adjusting step.

(15) The method of item 14, further comprising the step of: cutting a material so as to create the substrate from the material.

(16) The method of item 14, further comprising the steps of: forming the resist film on the substrate; and developing the resist film, on which the diffraction gratings are depicted in the depicting step, to create the mother die having the predetermined diffraction structure.

(17) The method of item 14, further comprising the step of: etching the mother die created in the developing step.

(18) A mother die of a mold utilized for molding an optical element having a predetermined diffraction structure, the mother die being manufactured by a method comprising the steps of: measuring a contour of a substrate, on which the predetermined diffraction structure is depicted, and/or a thickness of a resist film formed on the substrate, so as to detect height errors in surface heights in comparison with specified values of a surface height distribution of the substrate and/or thickness errors of the resist film in comparison with specified values of a film thickness distribution of the resist film; adjusting a depicting mode for depicting each of diffraction gratings, which constitute the predetermined diffraction structure, in response to the height errors and/or the thickness errors detected in the measuring step, so as to compensate for a phase change of diffracted light caused by each of the height errors and/or each of the thickness errors corresponding to each of the diffraction gratings; and depicting each of the diffraction gratings by scanning an electron beam onto the resist film formed on the substrate, according to the depicting mode adjusted in the adjusting step.

(19) A method for manufacturing mold utilized for molding an optical element having a predetermined diffraction structure, the mold being manufactured from a mother die and the predetermined diffraction structure being transferred to the mold from the mother die by applying electrocast processing, the mother die being manufactured by a method comprising the steps of: measuring a contour of a substrate, on which the predetermined diffraction structure is depicted, and/or a thickness of a resist film formed on the substrate, so as to detect height errors in surface heights in comparison with specified values of a surface height distribution of the substrate and/or thickness errors of the resist film in comparison with specified values of a film thickness distribution of the resist film; adjusting a depicting mode for depicting each of diffraction gratings, which constitute the predetermined diffraction structure, in response to the height errors and/or the thickness errors detected in the measuring step, so as to compensate for a phase change of diffracted light caused by each of the height errors and/or each of the thickness errors corresponding to each of the diffraction gratings; and depicting each of the diffraction gratings by scanning an electron beam onto the resist film formed on the substrate, according to the depicting mode adjusted in the adjusting step.

(20) A mold utilized for molding an optical element having a predetermined diffraction structure, the mold being manufactured from a mother die and the predetermined diffraction structure being transferred to the mold from the mother die by applying electrocast processing, the mother die being manufactured by a method comprising the steps of: measuring a contour of a substrate, on which the predetermined diffraction structure is depicted, and/or a thickness of a resist film formed on the substrate, so as to detect height errors in surface heights in comparison with specified values of a surface height distribution of the substrate and/or thickness errors of the resist film in comparison with specified values of a film thickness distribution of the resist film; adjusting a depicting mode for depicting each of diffraction gratings, which constitute the predetermined diffraction structure, in response to the height errors and/or the thickness errors detected in the measuring step, so as to compensate for a phase change of diffracted light caused by each of the height errors and/or each of the thickness errors corresponding to each of the diffraction gratings; and depicting each of the diffraction gratings by scanning an electron beam onto the resist film formed on the substrate, according to the depicting mode adjusted in the adjusting step.

(21) An optical element, molded by utilizing a mold and having a predetermined diffraction structure, the mold being manufactured from a mother die and the predetermined diffraction structure being transferred to the mold from the mother die by applying electrocast processing, the mother die being manufactured by a method comprising the steps of: measuring a contour of a substrate, on which the predetermined diffraction structure is depicted, and/or a thickness of a resist film formed on the substrate, so as to detect height errors in surface heights in comparison with specified values of a surface height distribution of the substrate and/or thickness errors of the resist film in comparison with specified values of a film thickness distribution of the resist film; adjusting a depicting mode for depicting each of diffraction gratings, which constitute the predetermined diffraction structure, in response to the height errors and/or the thickness errors detected in the measuring step, so as to compensate for a phase change of diffracted light caused by each of the height errors and/or each of the thickness errors corresponding to each of the diffraction gratings; and depicting each of the diffraction gratings by scanning an electron beam onto the resist film formed on the substrate, according to the depicting mode adjusted in the adjusting step.

(22) An apparatus for depicting a predetermined diffraction structure on a substrate by scanning an electron beam onto the substrate, comprising: an electron-beam scanning section, that includes an electron-beam irradiating device to irradiate the electron beam and an electron-beam deflecting device to deflect the electron beam irradiated by the electron-beam irradiating device, to scan the electron beam onto the substrate; a contour measuring section to measure a contour of the substrate so as to detect height errors in surface heights in comparison with specified values of a surface height distribution of the substrate; a depicting-mode adjusting section to adjust a depicting mode for depicting each of diffraction gratings, which constitute the predetermined diffraction structure, in response to the height errors detected by the contour measuring section, so as to compensate for a phase change of diffracted light caused by each of the height errors corresponding to each of the diffraction gratings; and a controlling section to control the electron-beam scanning section so as to depict each of the diffraction gratings by scanning the electron beam onto the substrate, according to the depicting mode adjusted by the depicting-mode adjusting section.

(23) The apparatus of item 22, wherein the depicting mode represents each spacing between the diffraction gratings.

(24) The apparatus of item 23, wherein the depicting-mode adjusting section adjusts a space between the diffraction gratings to a small value when a concerned error, being one of the height errors, is positive, while adjusts a space between the diffraction gratings to a large value when a concerned error, being one of the height errors, is negative.

(25) The apparatus of item 22, wherein the depicting mode represents a dose of the electron beam for depicting each of the diffraction gratings.

(26) The apparatus of item 25, wherein, when a concerned error being one of the height errors is positive, the depicting-mode adjusting section adjusts the dose of the electron beam to a large value, to such an extent that it is equivalent to an amount for depicting the concerned error, while, when a concerned error being one of the height errors is negative, the depicting-mode adjusting section adjusts the dose of the electron beam to a small value, to such an extent that it is equivalent to an amount for depicting the concerned error.

(27) An apparatus for depicting a predetermined diffraction structure on a substrate by scanning an electron beam onto the substrate, comprising: an electron-beam scanning section, that includes an electron-beam irradiating device to irradiate the electron beam and an electron-beam deflecting device to deflect the electron beam irradiated by the electron-beam irradiating device, to scan the electron beam onto the substrate; a film-thickness measuring section to measure a thickness of a resist film formed on the substrate so as to detect thickness errors of the resist film in comparison with specified values of a film thickness distribution of the resist film; a depicting-mode adjusting section to adjust a depicting mode for depicting each of diffraction gratings, which constitute the predetermined diffraction structure, in response to the thickness errors detected by the film-thickness measuring section, so as to compensate for a phase change of diffracted light caused by each of the thickness errors corresponding to each of the diffraction gratings; and a controlling section to control the electron-beam scanning section so as to depict each of the diffraction gratings by scanning the electron beam onto the resist film, according to the depicting mode adjusted by the depicting-mode adjusting section.

(28) The apparatus of item 27, wherein the depicting mode represents each spacing between the diffraction gratings.

(29) The apparatus of item 28, wherein the depicting-mode adjusting section adjusts a space between the diffraction gratings to a small value when a concerned error, being one of the thickness errors, is positive, while adjusts a space between the diffraction gratings to a large value when a concerned error, being one of the thickness errors, is negative.

(30) The apparatus of item 27, wherein the depicting mode represents a dose of the electron beam for depicting each of the diffraction gratings.

(31) The apparatus of item 30, wherein, when a concerned error being one of the thickness errors is positive, the depicting-mode adjusting section adjusts the dose of the electron beam to a large value, to such an extent that it is equivalent to an amount for depicting the concerned error, while, when a concerned error being one of the thickness errors is negative, the depicting-mode adjusting section adjusts the dose of the electron beam to a small value, to such an extent that it is equivalent to an amount for depicting the concerned error.

Further, to overcome the abovementioned problems, other electron beam depicting methods and apparatus, embodied in the present invention, will be described as follow:

(32) An electron beam depicting method, characterized in that,

in the electron beam depicting method for depicting a predetermined diffraction structure on a base material by scanning an electron beam onto the base material, serving as a substrate, the method includes:

a shape measuring process for measuring errors from specified values of a surface height distribution of the base material;

a depict adjusting process for adjusting a space between individual diffraction gratings so as to compensate for a phase change of diffracted light caused by each of the errors corresponding to each of the diffraction gratings, which constitute the diffraction structure, in response to the errors from specified values of a surface height distribution; and

a depicting process for depicting each of the diffraction gratings by scanning the electron beam, according to the adjusted space adjusted in the above process.

(33) The electron beam depicting method, described in item 32, characterized in that the method further includes:

a film thickness measuring process for measuring errors from specified values of a film thickness distribution of a resist film formed on the base material; and

in the depict adjusting process, the space between the individual diffraction gratings is adjusted so as to compensate for the phase change of the diffracted light, caused by each of the errors corresponding to each of the diffraction gratings which constitute the diffraction structure, in response to the errors from the specified values of a surface height distribution and the other errors from the specified values of a film thickness distribution.

(34) An electron beam depicting method, characterized in that,

in the electron beam depicting method for depicting a predetermined diffraction structure on a base material by scanning an electron beam onto the base material, the method includes:

a film thickness measuring process for measuring errors from specified values of a film thickness distribution of a resist film formed on the base material

a depict adjusting process for adjusting a space between individual diffraction gratings so as to compensate for a phase change of diffracted light caused by each of the errors corresponding to each of the diffraction gratings, which constitute the diffraction structure, in response to the errors from the specified values of a film thickness distribution; and

a depicting process for depicting each of the diffraction gratings by scanning the electron beam, according to the adjusted space adjusted in the above process.

(35) The electron beam depicting method, described in anyone of items 32-34, characterized in that,

in the depict adjusting process, when the error is positive, the space between the individual diffraction gratings is adjusted to a small value, while, when the error is negative, the space between the individual diffraction gratings is adjusted to a large value.

(36) The electron beam depicting method, described in anyone of items 32-35, characterized in that,

the depicted surface of the base material has a carved shape.

(37) A mother die manufacturing method, characterized in that,

in the mother die manufacturing method for manufacturing the mother die of a metallic mold for molding an optical element by employing the base material depicted by anyone of the electron beam depicting methods described in anyone of items 32-36, the method includes:

a cut machining process for acquiring the base material by cutting a raw material.

(38) The mother die manufacturing method, described in item 37, characterized in that

a resist film forming process for forming a resist film on the base material acquired in the cut machining process.

(39) The mother die manufacturing method, described in item 37 or 38, characterized in that

a developing process for acquiring the mother die having the predetermined diffraction structure by developing the resist film on the base material depicted in the depicting process.

(40) The mother die manufacturing method, described in item 39, characterized in that the method further includes:

an etching process for etching the base material developed in the developing process.

(41) A mother die, characterized in that, the mother die manufactured by employing the mother die manufacturing method, described in anyone of items 37-40.

(42) A metallic mold manufacturing method, characterized in that

a metallic mold, on which the predetermined structure on the mother die is transferred, is acquired by applying an electrocast processing by means of the mother die described in item 41.

(43) A metallic mold, characterized in that the metallic mold is manufactured by employing the metallic mold manufacturing method, described in item 42.

(44) An optical element, characterized in that the optical element is molded by employing the metallic mold, described in item 43.

(45) An electron beam depicting apparatus, characterized in that,

in the electron beam depicting apparatus for depicting a predetermined diffraction structure on a base material by scanning an electron beam onto the base material, the apparatus includes:

electron-beam irradiating means for irradiating the electron beam onto the base material;

electron-beam scanning means for scanning the electron beam by deflecting the electron beam irradiated by the electron-beam irradiating means;

shape information acquiring means for acquiring errors from specified values of a surface height distribution of the substrate;

depict adjusting means for adjusting a space between individual diffraction gratings so as to compensate for a phase change of diffracted light caused by each of the errors corresponding to each of the diffraction gratings, which constitute the diffraction structure, in response to the errors from specified values of a surface height distribution; and

controlling means for controlling the electron-beam scanning section so as to depict each of the diffraction gratings by scanning the electron beam onto the base material according to the adjusted space between the individual diffraction gratings.

(46) The electron beam depicting apparatus, described in item 45, characterized in that the apparatus further includes:

film thickness information acquiring means for acquiring errors from specified values of a film thickness distribution of a resist film formed on the base material, and

the depict adjusting means adjusts the space between the individual diffraction gratings, so as to compensate for the phase change of the diffracted light, caused by each of the errors corresponding to each of the diffraction gratings which constitute the diffraction structure, in response to the errors from the specified values of a surface height distribution and the other errors from the specified values of a film thickness distribution.

(47) An electron beam depicting apparatus, characterized in that,

in the electron beam depicting apparatus for depicting a predetermined diffraction structure on a base material by scanning an electron beam onto the base material, the method includes:

electron-beam irradiating means for irradiating the electron beam onto the base material;

electron-beam scanning means for scanning the electron beam by deflecting the electron beam irradiated by the electron-beam irradiating means;

film thickness information acquiring means for acquiring errors from specified values of a film thickness distribution of a resist film formed on the base material, depict adjusting means for adjusting a space between individual diffraction gratings so as to compensate for a phase change of diffracted light caused by each of the errors corresponding to each of the diffraction gratings, which constitute the diffraction structure, in response to the errors from specified values of a film thickness distribution; and

controlling means for controlling the electron-beam scanning section so as to depict each of the diffraction gratings by scanning the electron beam onto the base material according to the adjusted space between the individual diffraction gratings.

(48) The electron beam depicting apparatus, described in anyone of items 45-47, characterized in that,

when the error is positive, the depict adjusting means adjusts the space between the individual diffraction gratings to a small value, while, when a error is negative, the depict adjusting means adjusts the space between the individual diffraction gratings to a large value.

(49) An electron beam depicting method, characterized in that,

in the electron beam depicting method for depicting a predetermined diffraction structure on a base material by scanning an electron beam onto the base material, the method includes:

a shape measuring process for measuring errors from specified values of a surface height distribution of the base material;

a depict adjusting process for adjusting an irradiating amount of the electron beam so as to compensate for the errors from the specified values of the surface height distribution; and

a depicting process for depicting each of the diffraction gratings by irradiating and scanning the electron beam, according to the adjusted irradiating amount adjusted in the above process.

(50) The electron beam depicting method, described in item 49, characterized in that the method further includes:

a film thickness measuring process for measuring errors from specified values of a film thickness distribution of a resist film formed on the base material, and

in the depict adjusting process, the irradiating amount of the electron beam, for depicting each of the diffraction gratings, is adjusted so as to compensate for the errors from the specified values of a surface height distribution and the other errors from the specified values of the film thickness distribution.

(51) An electron beam depicting method, characterized in that,

in the electron beam depicting method for depicting a predetermined diffraction structure on a base material by scanning an electron beam onto the base material, the method includes:

a film thickness measuring process for measuring errors from specified values of a film thickness distribution of a resist film formed on the base material;

a depict adjusting process for adjusting an irradiating amount of the electron beam so as to compensate for the errors from the specified values of the film thickness distribution; and

a depicting process for depicting each of the diffraction gratings by irradiating and scanning the electron beam, according to the adjusted irradiating amount adjusted in the above process.

(52) The electron beam depicting method, described in anyone of items 49-51, characterized in that,

in the depict adjusting process, when the error is positive, the irradiating amount of the electron beam for depicting each of the diffraction gratings is adjusted to a large value increased by an amount equivalent for depicting the error, while, when the error is negative, the irradiating amount of the electron beam for depicting each of the diffraction gratings is adjusted to a small value decreased by an amount equivalent for depicting the error.

(53) The electron beam depicting method, described in anyone of items 49-52, characterized in that,

the depicted surface of the base material has a carved shape.

(54) A mother die manufacturing method, characterized in that,

in the mother die manufacturing method for manufacturing the mother die of a metallic mold for molding an optical element by employing the base material depicted by anyone of the electron beam depicting methods described in anyone of items 49-53, the method includes:

a cut machining process for acquiring the base material by cutting a raw material.

(55) A mother die manufacturing method, characterized in that,

in the mother die manufacturing method for manufacturing the mother die of a metallic mold for molding an optical element by employing the base material depicted by anyone of the electron beam depicting methods described in anyone of items 50-53, the method includes:

a resist film forming process for forming a resist film on the base material acquired in the cut machining process.

(56) The mother die manufacturing method, described in item 54 or 55, characterized in that

a developing process for acquiring the mother die having the predetermined diffraction structure by developing the resist film on the base material depicted in the depicting process.

(57) The mother die manufacturing method, described in item 56, characterized in that the method further includes:

an etching process for etching the base material developed in the developing process.

(58) A mother die, characterized in that, the mother die manufactured by employing the mother die manufacturing method, described in anyone of items 54-57.

(59) A metallic mold manufacturing method, characterized in that

a metallic mold, on which the predetermined structure on the mother die is transferred, is acquired by applying an electrocast processing by means of the mother die described in item 58.

(60) A metallic mold, characterized in that the metallic mold is manufactured by employing the metallic mold manufacturing method, described in item 59.

(61) An optical element, characterized in that the optical element is molded by employing the metallic mold, described in item 60.

(62) An electron beam depicting apparatus, characterized in that,

in the electron beam depicting apparatus for depicting a predetermined diffraction structure on a base material by scanning an electron beam onto the base material, the apparatus includes:

electron-beam irradiating means for irradiating the electron beam onto the base material;

electron-beam scanning means for scanning the electron beam by deflecting the electron beam irradiated by the electron-beam irradiating means;

shape information acquiring means for acquiring errors from specified values of a surface height distribution of the substrate;

a depict adjusting means for adjusting an irradiating amount of the electron beam so as to compensate for the errors from the specified values of the surface height distribution; and

controlling means for controlling the electron-beam irradiating means and/or the electron-beam scanning means so as to depict each of the diffraction gratings by scanning the electron beam onto the base material according to the adjusted irradiating amount.

(63) The electron beam depicting apparatus, described in item 62, characterized in that the apparatus further includes:

film thickness information acquiring means for acquiring errors from specified values of a film thickness distribution of a resist film formed on the base material, and

the depict adjusting means adjusts the irradiating amount of the electron beam for depicting each of the diffraction gratings, so as to compensate for the errors from the specified values of a surface height distribution and the other errors from the specified values of a film thickness distribution.

(64) An electron beam depicting apparatus, characterized in that,

in the electron beam depicting apparatus for depicting a predetermined diffraction structure on a base material by scanning an electron beam onto the base material, the method includes:

electron-beam irradiating means for irradiating the electron beam onto the base material;

electron-beam scanning means for scanning the electron beam by deflecting the electron beam irradiated by the electron-beam irradiating means;

film thickness information acquiring means for acquiring errors from specified values of a film thickness distribution of a resist film formed on the base material;

a depict adjusting means for adjusting an irradiating amount of the electron beam so as to compensate for the errors from the specified values of the film thickness distribution; and

controlling means for controlling the electron-beam irradiating means and/or the electron-beam scanning means so as to depict each of the diffraction gratings by scanning the electron beam onto the base material according to the adjusted irradiating amount.

(65) The electron beam depicting apparatus, described in anyone of items 62-64, characterized in that, when the error is positive, the depict adjusting means adjusts the irradiating amount of the electron beam for depicting each of the diffraction gratings to a large value increased by an amount equivalent for depicting the error, while, when the error is negative, the depict adjusting means adjusts the irradiating amount of the electron beam for depicting each of the diffraction gratings to a small value decreased by an amount equivalent for depicting the error.

### BRIEF DESCRIPTION OF THE DRAWINGS

Other objects and advantages of the present invention will become apparent upon reading the following detailed description and upon reference to the drawings in which:

FIG. 1 shows a flowchart indicating processes of a manufacturing method of a mother die, an electron beam depicting method and a manufacturing method of a metallic mold, embodied in the present invention;

FIG. 2 shows a continued flowchart indicating processes of a manufacturing method of a mother die, an electron beam depicting method and a manufacturing method of a metallic mold, embodied in the present invention;

FIG. 3(a), FIG. 3(b), FIG. 3(c), FIG. 3(d), FIG. 3(e), FIG. 3(f) and FIG. 3(g) show cross sectional views of assembled bodies of a raw material of mother die and an electrode member, serving as a member E;

FIG. 4 shows a perspective view of member E to which a jig is attached;

FIG. 5 shows a top view of member E shown in FIG. 4;

FIG. 6 shows an explanatory drawing of an overall configuration of a shape measuring apparatus;

FIG. 7 shows an explanatory drawing of an overall configuration of an electron beam depicting apparatus;

FIG. 8 shows an explanatory drawing for explaining a Beam Waist of an electron beam;

FIG. 9 shows an explanatory drawing of an overall configuration of a measuring apparatus;

FIG. 10 shows an explanatory drawing for explaining a measuring principle of a measuring apparatus;

FIG. 11 shows a graph of a characteristic curve indicating a relationship between a signal output and a base material;

FIG. 12(A) and FIG. 12(B) show explanatory drawings of a base material depicted by an electron beam depicting apparatus, and FIG. 12(C) shows an explanatory drawing for explaining a depicting principle of an electron beam depicting apparatus;

FIG. 13 shows an explanatory drawing of a configuration of a controlling system in an electron beam depicting apparatus;

FIG. 14(A) and FIG. 14(B) show explanatory drawings for explaining a process for adjusting adjacent spaces between diffraction rings, which constitute a diffraction structure to be depicted on a base material;

FIG. 15(A) and FIG. 15(B) show explanatory drawings for explaining a relationship between shape errors of a curved surface (a depicted surface) of a base material and compensating amounts of adjacent spaces between diffraction rings;

FIG. 16(A) and FIG. 16(B) show explanatory drawings for explaining a process for adjusting dose amounts corresponding to shape errors of a curved surface (a depicted surface) of a base material;

FIG. 17 shows a graph indicting a relationship between a dose, required for increasing a developing velocity on a curved surface (a depicted surface) of a base material by a predetermined amount, and a depth from the curved surface at a point onto which the dose is applied;

FIG. 18 shows an explanatory drawing for explaining a relationship between shape errors of a curved surface (a depicted surface) of a base material and compensated dose amounts for depicting diffraction rings;

FIG. 19 shows a cross sectional view of a movable core; and

FIG. 20 shows a cross sectional view of a mold for molding an optical element by employing a movable core.

### DETAILED DESCRIPTION OF THE PREFERRED EMBODIMENT

Referring to drawings, the preferred first and second embodiments of the present invention will be specifically described below. Hereupon, in the following, they will be described, along a flow up to obtaining an optical element, in the order of a production method of the mother die, an electron beam depicting method, an electron beam depicting apparatus, a production method of a metallic mold, and an optical element. Further, the first embodiment will be mainly described, and relating to the second embodiment, only a different part will be described.

### A Production Method of the Mother Die: The First Part

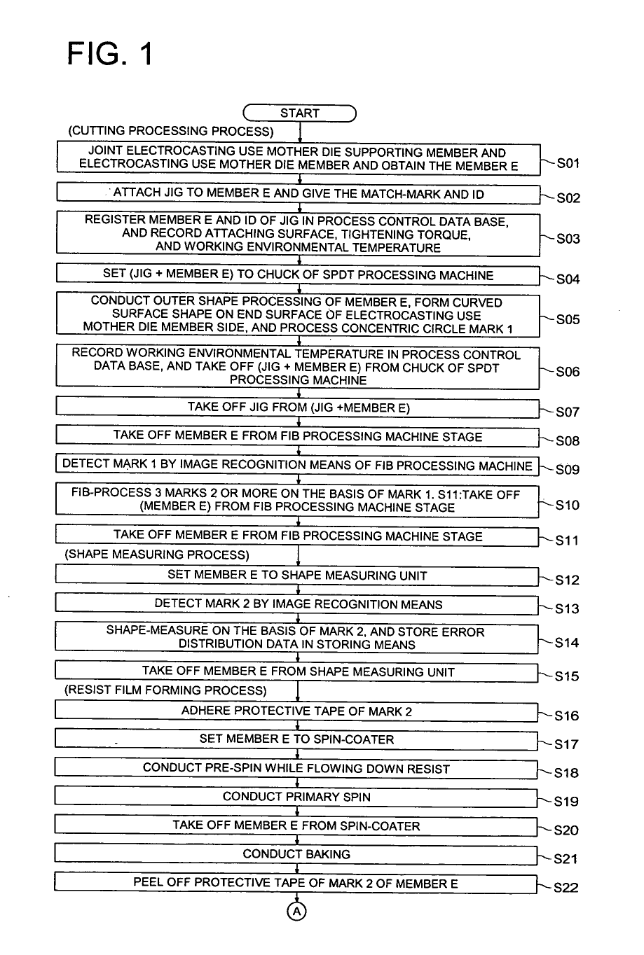

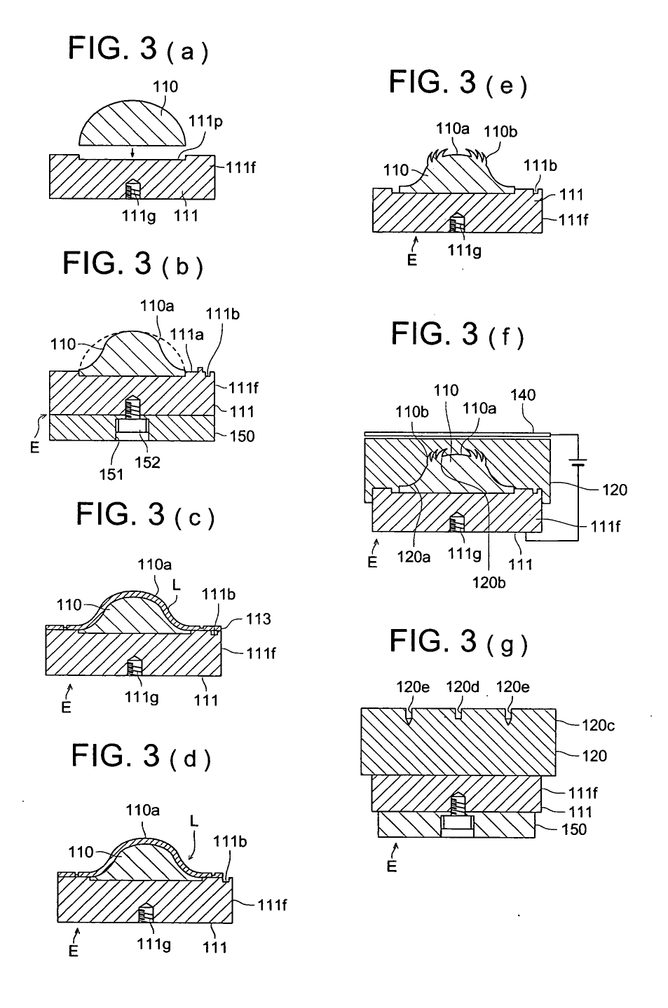

Initially, referring to FIG. 3, along a flow of a flowchart shown in FIG. 1, a production method of the mother die (the first part) will be described.

<Cutting Processing Process>

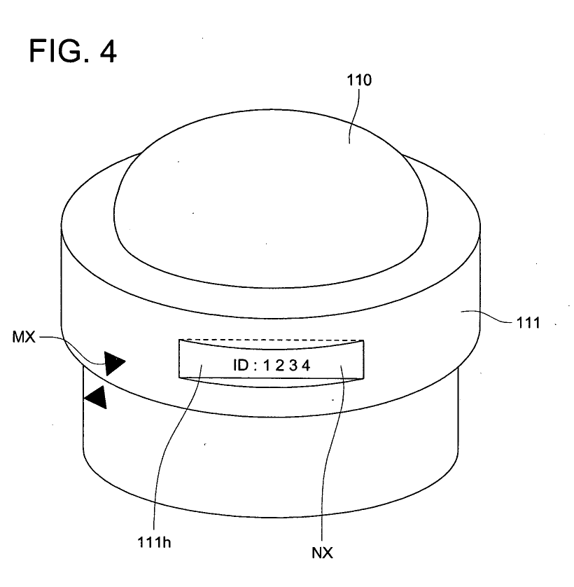

As shown in FIG. 1, initially, a raw material 110 of the mother die having about semi-sphere type shape formed of resin material such as SiO₂, poly-silicon or poly-olefin is buried in a central opening 111p of a disk-like raw material 111 formed of a conductive raw material such as the metal, and fixed by an adhesive agent so as not to be relatively rotated (refer to FIG. 3(a)), and the member E is obtained (step S01). Hereupon, the member E corresponds to a “raw material” of the present invention. Next, by a bolt 152, which is penetrated through a central hole 151 of a tool (hereinafter, also referred to as a jig) 150 and engaged with a screw hole 111g of the base material 111, the jig 150 is attached to the base material 111, and a match-mark MX and an ID number NX are given (step S02). As shown in FIG. 4, this ID number NX is the number given to each of attached jig 150, and functions as the information to specify that. Hereupon, in the present example, the ID number NX is etched by the laser depicting in a groove 111h in which the outer peripheral surface of the base material 111 is cut in a thin plane in the tangential line direction, however, it may also be a print. Further, the groove may also be a full peripheral groove having the same depth. Further, the match-mark MX to match the phase with that of the base material 111 can also be etched by the laser processing.

Next, in a process control data base structured in a computer (not shown in the drawings) in a form of making correspond to this member E, the ID number NX of the jig, an attaching surface (direction), a tightening torque, and a working environmental temperature (atmospheric temperature) are stored (step S03). After that, to a chuck of a super-precision lathe (an SPDT processing machine) (not shown in the drawings) the member E is attached through the jig 150 (step S04). Further, while the member E is rotated, when an outer peripheral surface 111f of the base material 111 is cutting processed by a diamond tool, to the rotation axis of the super precision lathe, for example, SPDT (Single Point Diamond Turning) processing machine, it is accurately formed, and further, the upper surface of the raw material 110 of the mother die is cutting processed as shown in FIG. 3(b), and a mother optical surface (corresponds to an optical curved surface of the optical element to be molded) 110a is formed, and a peripheral groove 111a (the first mark) is cutting processed on the upper surface of the base material 111 (step S05). In this case, while the temperature control is conducted, a feed amount and a notching amount are controlled, and the surface roughness from 50 nm to 20 nm of the curved surface is obtained. Further, in this case, although a position of an optical axis of the mother optical surface 110a can not be confirmed from its outer shape, because they are simultaneously processed, the mother optical surface 110a and the peripheral groove 111a are accurately coaxially formed, and further, the outer peripheral surface 111f of the base material 111 formed on a cylindrical surface is also accurately coaxially formed with the optical axis. Herein, the peripheral groove 111a may be formed of a plurality of grooves formed of, for example, a dark field portion (corresponds to a convex portion) and a light field portion (corresponds to a convex portion), and it is more preferable that it has a plurality of dark field portions and light field portions (this is easily formed when the leading edge of the diamond tool has a convex and concave portions). Further, by the concave and convex shape of the peripheral groove 111a, it can be made to function also as a bank for the spattering prevention of the resist, which is coated as will be described later.

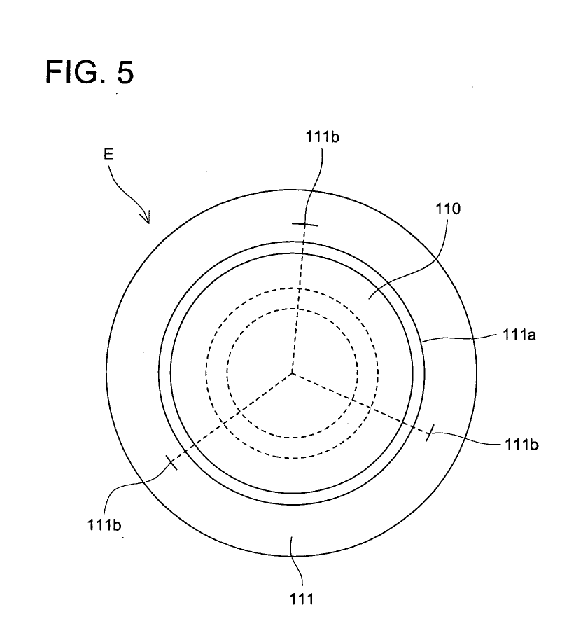

Further, in the process control data base structured in a computer (not shown in the drawings) a working circumstantial temperature at the time of cutting processing of the member E is stored, and the member E is taken off from the SPDT processing machine (step S06), a bolt 152 is loosened and the jig 150 is taken off from the member E (step S07). Then, a processing flaw (tool mark) by the diamond tool which looks like rainbow colors in the visual observation, is polishing processed, and polished until the rainbow colors are not observed. Further, the member E is set onto a stage of an FIB (Focused Ion Beam) processing machine (step S08). Next, the peripheral groove 111a in the member E on the stage of the FIB processing machine is read, and for example, a position of the optical axis of the raw material 110 of the mother die is determined from an inside edge (step S09), and from the determined optical axis, 3 (more than 4 may also be allowed) second marks 111b are depicted at equal distance on the base material 111 (refer to FIG. 3(b) and FIG. 5) (step S10). Because the width of the peripheral groove 111a which is processed and formed by the diamond tool, is comparatively wide, there is a possibility that a fact that, by using this, the reference of the processing is made, results in lowering the processing accuracy, however, because the FIB processing machine can form a line having the high accuracy whose width is about 20 nm, for example, when a cross line is formed, fine marks of 20 nm×20 nm can be formed, and when that is made the reference of the processing, the higher accurate processing can be conducted. Next, the member E is taken off from the stage of the FIB processing machine (step S11).

### Electron Beam Depicting Method: The First Part

Subsequently, referring to FIG. 3, along a flow of the flowchart shown in FIG. 1, the electron beam depicting method (the first part) will be described.

<Shape Measuring Process>

As shown in FIG. 1, subsequently, the member E is set to the shape measuring unit (having an image recognizing means and storing means), which will be described later, (step S12), and by using the image recognizing means of the shape measuring unit, the second mark 111b is detected (step S13). Further, the third dimensional coordinates of the mother optical surface 111a of the base material 110 of the mother die which is obtained by the measurement or used for the super precision lathe, are converted into the third dimensional coordinates according to the second mark 111b and further, from the third dimensional coordinates according to this second mark 111b, the regulated value relating to the height position of the mother optical surface 110a of the base material 110 of the mother die, that is, the error distribution data from the designed value is made, and they are stored in the storing means (step S14). In this manner, a fact that the mother optical surface 110a is stored again in the new third dimensional coordinates, is because, when the electron beam depicting is conducted in the depicting process which will be described later, in order to adjust the focal depth of the electron beam to the depicted surface of the mother optical surface 110a, it is necessary that the relative position of an electron gun and the member E is adjusted. Hereupon, the second mark 111b can, when measurement, be used as a mark for the position recognition by which the operator visually confirms where is the reference point of the coordinates according to the measured data. After that, the member E is taken off from the shape measuring unit (step S15).

(Shape Measuring Unit)

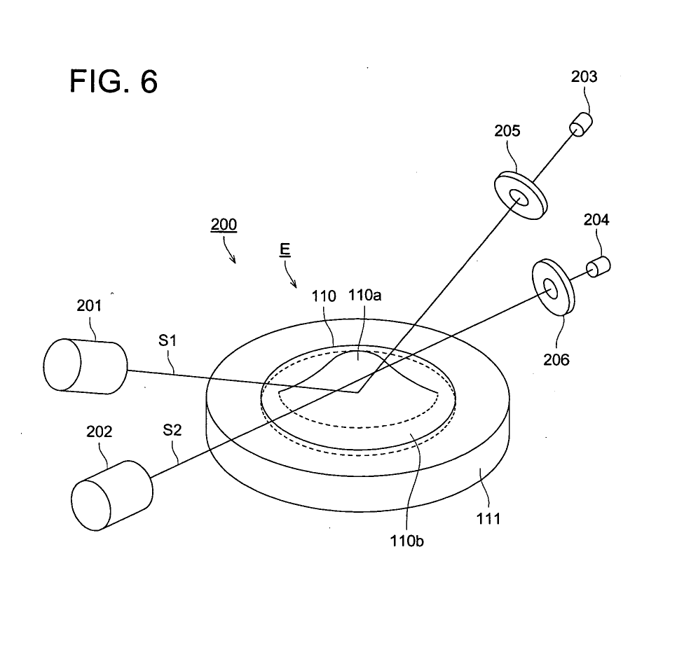

Herein, referring to FIG. 6, the shape measuring unit will be described.

As shown in FIG. 6, the measuring unit 200 has the first laser length measuring unit 201, the second laser length measuring unit 202, a pinhole 205, a pinhole 206, the first light receiving section 203, and second light receiving 204, and further, is structured by including a measurement calculation section (not shown in the drawings) for calculating these measuring results, a storing section for storing the measuring results, and a control means (not shown in the drawings) provided with each kind of control system.

In such a structure, the first light beam S1 is irradiated onto the member E from the first laser length measuring unit 201, and the first light beam S1 reflected by a flat portion 110b of the raw material 110 of the mother die is received by the first light receiving section 203 through the pinhole 205, and the first light intensity distribution is detected.

In this case, because the first light beam S1 is reflected by the flat portion 110b of the raw material 110 of the mother die, according to the first intensity distribution, the (height) position on the flat portion 110b of the raw material 110 of the mother die is measured and calculated.

Further, the second light beam S2 is irradiated from the second laser length measuring unit 202 onto the member E from the different direction from the first light beam S1, and the second light beam S2 which transmits the mother optical surface 110a of the raw material 110 of the mother die, is received by the second light receiving section 204 through the pinhole 206, and the second light intensity distribution is detected.

In this case, because the second light beam S2 transmits on the mother optical surface 110a of the raw material 110 of the mother die, according to the second intensity distribution, the (height) position on the mother optical surface 110a protruded from the flat portion of the raw material 110 of the mother die, is measured and calculated. Hereupon, the principle of the measurement calculation of the (height) position on the mother optical surface 110a of the raw material 110 of the mother die, will be described in a part of the measuring unit of the electron beam depicting apparatus which will be described later.

### The Production Method of the Mother Die: The Second Part

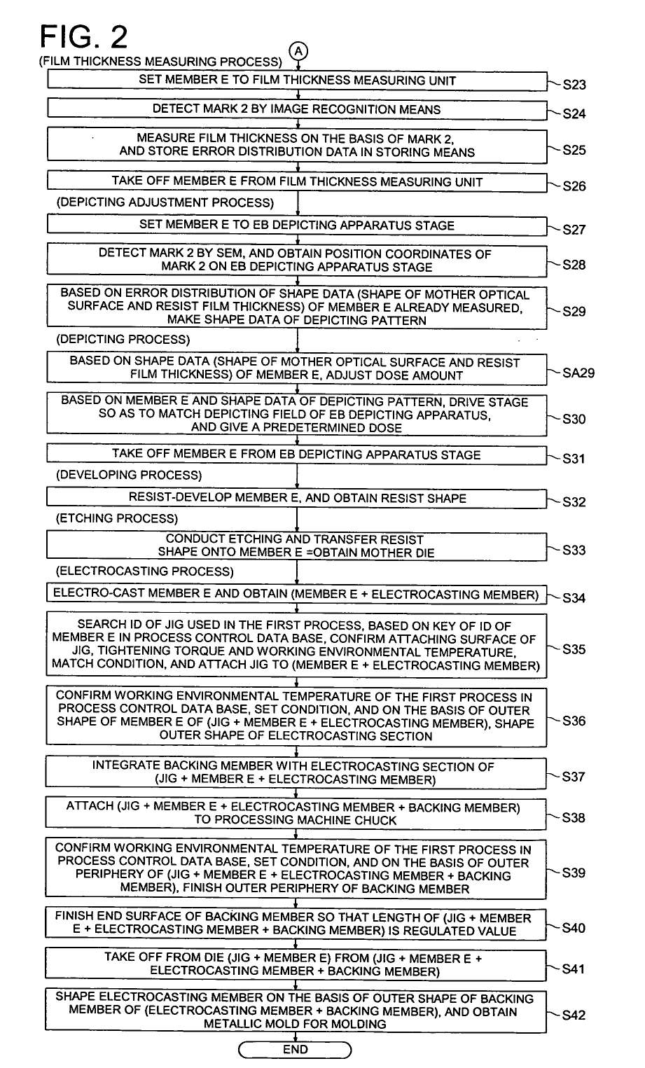

Subsequently, referring to FIG. 3, the production method of the mother die (the second part) will be described along a flow of the flowchart shown in FIG. 1 and FIG. 2.

<Resist Film Forming Process>

Returned to FIG. 1, next, a protective tape 113 is adhered onto the second mark 111b (refer to FIG. 3(c)) (step 16). This protective tape 113 is one by which the resist L coated on the raw material 110 of the mother die in the after-processing is not adhered to the second mark 111b. This is for the reason that, when the resist L is adhered to the second mark 111b, the reading becomes inadequate as the reference of the processing. Hereupon, the protection by the protective tape is shown in FIG. 3(C), and a case where only one second mark 111b is protected, is shown, however, the other second mark 111b is also the same. Further, the member E is set to a spincoater (not shown in the drawings) (step S17), and while the resist L is flowed down on the raw material 110 of the mother die, a pre-spin by which the resist coated base material is rotated, is conducted (step S18), and after that, the flowing-down of the resist L is stopped, and a main spin by which the resist coated base material is rotated, is conducted, and the coating of the resist L is conducted (refer to FIG. 3(d)). When the pre-spin and the main spin are separated, a uniform film thickness resist L can be coated on the mother optical surface 110a which is a complicated curved surface. Herein, for the resist L, the high polymer resin material which is hardened by heating or the ultra-violet ray, is used, and it has the characteristic that the bind between molecules is cut and resolved corresponding to the energy amount given by the electron beam (the resolved part is removed by the developing liquid which will be described later).

After that, the member E is taken off from the spin-coater (step S20), and by conducting the baking (heating) processing on the member E, the film of the resist L is stabled (step S21). The temperature in this case is about 170° C., and the member E is heated for about 20 minutes. Further, the protective tape 113 is peeled out (step S22). The member E of such a situation is shown in FIG. 3(d).

### Electron Beam Depicting Method: The Second Part

Subsequently, referring to FIG. 3, the electron beam depicting method (the second part) will be described along a flow of the flowchart shown in FIG. 2.

<Film Thickness Measuring Process>

As shown in FIG. 2, further, the member E is set to the film thickness measuring unit (not shown in the drawings) (which has the image recognition means and storing means) (step S23), and by using the image recognition means of the film thickness measuring unit, the second mark 111b is detected (step S24). Further, the film thickness distribution of the resist L coated on the mother optical surface 110a of the base material 110 of the mother die is converted into the film thickness distribution according to the second mark 111b, and further, from the film thickness distribution according to the second mark 111b, the regulated value, that is, the error distribution data from the film thickness value which is to be obtained, is made, and they are stored in the storing means (step S25). In this manner, when the error distribution data from the regulated value of the film thickness of the resist L according to the second mark 111b is made, this can be made to correspond to the error distribution data from the designed value of the height position of the mother optical surface 110a of the base material 110 of the mother die by the above-described shape measuring unit. After that, the member E is taken off from the film thickness measuring unit (step S26).

<Depicting Adjustment Process>

Further, the member E is set to the third dimensional stage of the electron beam depicting apparatus which will be described later (step S27), the second mark 111b of the member E is detected through the measuring unit (scanning type electronic microscope (SEM): it is preferable that the SEM is attached to the electronic depicting apparatus), (step S28), and the detection result and the measurement information from the shape measuring unit 200 inputted from the input section and the film thickness measuring unit, specifically, the shape data of the member E, that is, the shape of the depicted surface (the film surface of the resist L) of the mother optical surface 110a is obtained from the third dimensional coordinates of the mother optical surface 110a, and the film thickness distribution of the resist L coated on the mother optical surface 110a, and further, according to each of error distribution data (the error distribution data from the designed value of the height position of the mother optical surface 110a, and the error distribution data from the regulated value of the film thickness of the resist L coated on the mother optical surface 110a), the shape data relating to a predetermined depicting pattern which is depicted on the depicted surface of the mother optical surface 110a is made (step S29). Hereupon, the detail of this depicting adjustment process will be described in a part of (the detail of the depicting adjustment process) which will be described later.

Herein, in the second example, from the shape of the depicted surface of the mother optical surface 110a (the film surface of the resist L), the shape data relating to a predetermined depicting pattern which is depicted on the depicted surface of the mother optical surface 110a is made (step S29). In this connection, the shape of the depicted surface of the mother optical surface 110a may also be measured by the measuring unit together with the detection of the second mark 111b of the member E.

Further, the irradiation amount of the electron beam when the diffractive ring-shaped zone, which structures a predetermined depicting pattern, is depicted, that is, the dose amount is adjusted. Specifically, the measured information from the shape measuring unit 200 inputted from the input section and the film thickness measuring unit, specifically, the shape data of the member E, that is, the shape of the depicted surface of the mother optical surface (film surface of the resist L) is obtained from the third dimensional coordinates of the mother optical surface 110a and the film thickness distribution of the resist L coated on the mother optical surface 110a, and further, according to each of error distribution data (the error distribution data from the designed value of the height position of the mother optical surface 110a, and the error distribution data from the regulated value of the film thickness of the resist L coated on the mother optical surface 110a), the dose amount is adjusted so that a predetermined shape can be obtained (step SA29). Hereupon, the detail of the depicting adjustment process will be described in a part of (the detail of the depicting adjustment process) which will be described later.

Further, in the depicting process of the above-described second example, in order to depict a predetermined depicting pattern on the shape of the obtained depicted surface, the third dimensional stage is moved so that the electron beam is focused onto the depicted surface, and the electron beam (refer to FIG. 3(d)) is irradiated so that it is a predetermined dose amount (the dose amount after it is corrected), and a predetermined depicting pattern, for example, each of the diffraction gratings corresponding to the diffraction structure, for example, the diffractive ring-shaped zone is depicted on the film of the resist L on the mother optical surface 110a (step S30).

<Depicting Process>

Returned to the first example, in order to depict a predetermined pattern on the shape of the obtained depicted surface, the third dimensional stage is moved so that the electron beam is focused onto the depicted surface, the electron beam (refer to FIG. 3(d)) is irradiated so that it is a predetermined dose amount, and a predetermined depicting pattern, for example, each of the diffraction gratings corresponding to the diffraction structure, for example, the diffractive ring-shaped zone is depicted on the film of the resist L on the mother optical surface 110a (step S30). In this case, the interval between the adjoining diffractive ring-shaped zones is adjusted according to the error distribution from the designed value of the height position of the mother optical surface 110a, and the error distribution from the regulated value of the film thickness of the resist L coated on the mother optical surface 110a.

(Structure of the Depicting Apparatus)

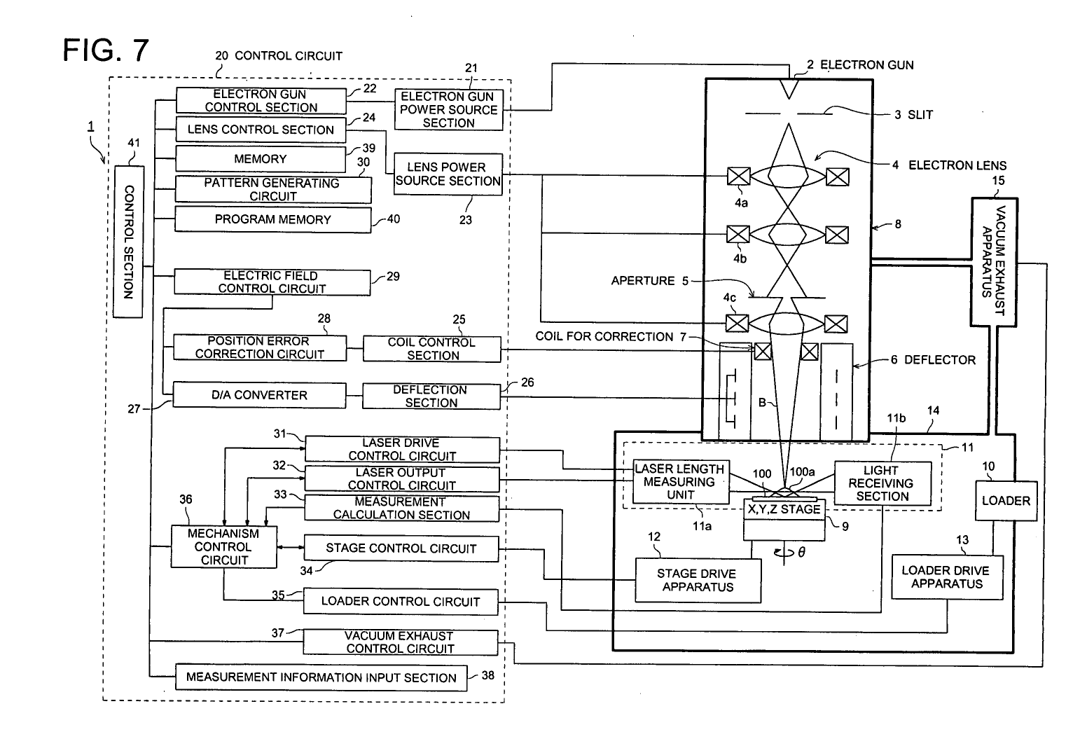

Herein, referring to FIG. 7, the overall structure of the electron beam depicting apparatus will be described. Hereupon, in the following, the member E on which the film of the resist L is formed on the mother optical surface 110a of the raw material 110 of the mother die, corresponds to the raw material 100.

As shown in FIG. 7, the electron beam depicting apparatus 1 forms an electronic ray probe which is large current and high resolving power and scans on the base material 100 of the depicting target at high speed, and it is structured by including an electron gun 2 by which the electronic ray probe of high resolving power is formed, and the electron beam is formed and irradiated onto the target, a slit 3 through which the electron beam from this electron gun 2 is transmitted, an electron lens 4 by which the focal position to the base material 100 of the electron beam transmitted through the slit 3 is controlled, an aperture 5 arranged on the path on which the electron beam is projected, a deflector 6 by which the scanning position on the base material 100 which is a target is controlled by deflecting the electron beam, and a correction coil 7 for correcting the deflection. Each section of them is arranged in a lens barrel 8 and maintained in a vacuum condition in the case where the electron beam is projected. Hereupon, the electron gun 2 corresponds to “the electron beam irradiation means” of the present invention. Further, the deflector 6 corresponds to “the scanning means” of the present invention.

Further, the electron beam depicting apparatus 1 is structured by including an XYZ stage 9 which is a loading table for loading the base material 100 which is a depicting object, a loader 10 which is a conveying means for conveying the base material 100 to the loading position on this XYZ stage 9, a measuring apparatus 11 which is a measuring means for measuring the reference point of the surface of the base material 100 on the XYZ stage 9, a stage drive apparatus 12 which is a drive means for driving the XYZ stage 9, a loader drive apparatus 13 for driving the loader, a vacuum exhaust apparatus 15 for exhausting the air so that inside of the lens barrel 8 and a casing 14 including the XYZ stage 9 is vacuum, and a control circuit 20 which is a control means for controlling them.

Hereupon, in the electron lens 4, when a plurality of electron lenses are generated by each of current values of each of coils 4a, 4b, and 4c separately arranged at a plurality of positions along the height direction, each of them is controlled, and the focal position of the electron beam is controlled.

The measuring apparatus 11 is structured by including a laser length measuring unit 11a by which the laser is irradiated onto the base material 100 and the base material 100 is measured, and a light receiving section 11b by which the laser light emitted by the laser length measuring unit 11a, is reflected on the base material 100, and the reflected light is received. Hereupon, the detail of this will be described later.

The stage drive apparatus 12 is structured by including an X-direction drive mechanism for driving the XYZ stage 9 in the X direction, a Y-direction drive mechanism for driving in the Y direction, a Z-direction drive mechanism for driving in the Z direction (the advancing direction of the electron beam), and a θ-direction drive mechanism for driving in the θ direction. Thereby, the XYZ stage 9 can be moved third dimensionally or the alignment can be conducted.

The control circuit 20 is structured by including an electron gun power supply section 21 for supplying the power to the electron gun 2, an electron gun control section 22 for adjusting and controlling the current and voltage in this electron gun power supply section 21, a lens power supply section 23 for moving the electron lens 4 (each of a plurality of electron lenses), and a lens control section 24 for adjusting and controlling each current corresponding to each electron lens in this lens power supply section 23.

Further, the control circuit 20 is structured by including a coil control section 25 for controlling a correction coil 7, a deflection section 26 for conducting the deflection in the molding direction by the deflector 6, and for conducting the deflection in a main scanning direction and sub-scanning direction, and a D/A converter 27 for converting a digital signal into an analog signal for controlling the deflection section 26.

Further, the control circuit 20 is structured by including a position error correction circuit 28 which corrects a position error in the deflector 6, that is, supplies a position error correction signal to the D/A converter 27 and accelerates the position error correction, or when the signal is supplied to the coil control section 25, conducts the position error correction by the correction coil 7, an electric field control circuit 29 which is an electric field control means for controlling the electric field of the electron beam, by controlling these position error correction circuit 28 and the D/A converter 27, and a pattern generation circuit 30 for generating the depicting pattern corresponding to the base material 100.

Further, the control circuit 20 is structured by including a laser drive control circuit 31 to conduct the drive control of the movement of the laser irradiation position and the angle of the laser irradiation angle, a laser output control circuit 32 for adjusting and controlling the output (the light intensity of the laser) of the laser irradiation light in the laser length measuring unit 11a, and a measurement calculation section 33 for calculating the measurement result according to the light receiving result by the light receiving section 11b.

Further, the control circuit 20 is structured by including a stage control circuit 34 for controlling the stage drive apparatus 12, a loader control circuit 35 for controlling the loader drive apparatus 13, a mechanism control circuit 36 for controlling the above-described laser drive circuit 31, laser output control circuit 32, measurement calculation section 33, stage control circuit 34, and loader control circuit 35, a vacuum exhaust control circuit 37 for controlling the vacuum exhaust of the vacuum exhaust apparatus 15, a measurement information input section 38 for inputting the measurement information from the above-described shape measuring apparatus or the film thickness measuring apparatus, a memory 39 which is a storing means for storing the inputted measurement information or the other information, a program memory 40 by which a control program for conducting each kind of controls is stored, and a control section 41 structured by, for example, CPU which conducts the control of each of these sections. Hereupon, the measurement information input section 38 corresponds to the “shape information obtaining means” and the “film thickness information obtaining means”.

(Depicting Processing)

In the electron beam depicting apparatus 1 having such a structure, when the base material 100 conveyed by the loader 10 is placed on the XYZ stage 9, after the air or dust in the lens barrel 8 and casing 14, is exhausted by the vacuum exhaust apparatus 15, the electron beam is irradiated from the electron gun 2.

The electron beam irradiated from the electron gun 2, is deflected by the deflector 6 through the electron lens 4, and when the deflected electron beam B (hereinafter, there is a case where only relating to the deflection controlled electron beam after passing through the electron lens 4, a sign of “electron beam B” is given), is irradiated onto the depicting position on the surface of the base material 100 on the XYZ stage 9, for example, the curved surface portion (curved surface) 100, the depicting is conducted.

In this case, by the measuring apparatus 11, the depicting position on the base material 100 (in the depicting position, at least the height position), or the position of the reference point as will be described later, is measured, the control circuit 20 adjusts and controls each of current values flowing in coils 4a, 4b, and 4c of the electron lens 4 according to the measurement result, and the focal position of the electron beam is controlled, and is moving controlled so that the focal position is the above-described depicting position.

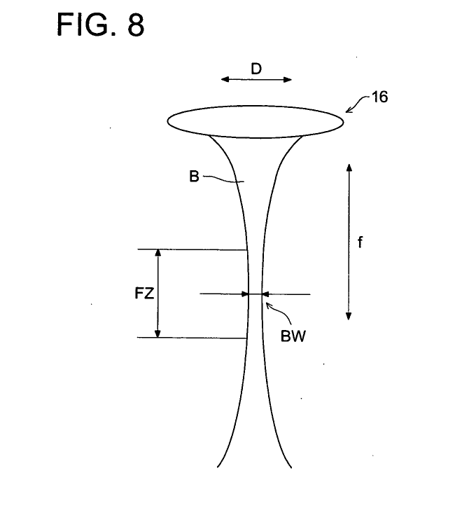

Hereupon, as shown in FIG. 8, the electron beam has a deep focal depth FZ, however, the electron beam B stopped down to the width D of the electron lens 4 forms a beam waist BW having about constant thickness, and the length in the electron beam advancing direction within the range of this beam waist BW corresponds to the focal depth FZ called herein. The focal position is a position in the electron beam advancing direction of this beam waist BW, and herein, it is defined as the central position in the electron beam advancing direction of the beam waist BW.

Alternatively, according to the measurement result, the control circuit 20 moves the XYZ stage 9 so that the focal position of the electron beam is the depicting position, by controlling the stage drive apparatus 12.

The relative movement control of the base material 100 and the focal position of the electron beam B may also be conducted by any one of the control of the focal position of the electron beam B and the control of the XYZ stage, or by using both of them, however, when the electron lens 4 is adjusted in the control of the electron beam B, because it is necessary that the error by the change of the deflection of the electron beam B is corrected, it is preferable that it is conducted by movement control of the XYZ stage 9.

(Measuring Apparatus)

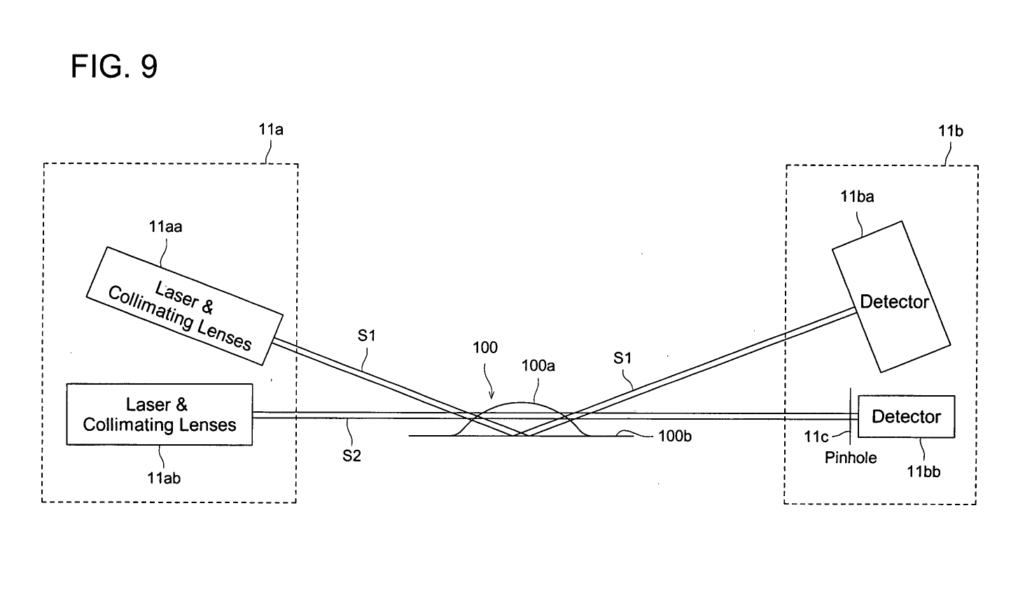

Herein, referring to FIG. 9, the measuring apparatus 11 will be described. As shown in FIG. 9, in more detail, the measuring apparatus 11 has the first laser length measuring unit 11aa and the second laser length measuring unit 11ab constituting the laser length measuring unit 11a, and the first light receiving section 11ba and the second light receiving section 11bb constituting the light receiving section 11b.

In such a structure, when the first light beam S1 is irradiated onto the base material 100 from the crossing direction with the electron beam by the first laser length measuring unit 11aa, and the first light beam S1 reflected on the flat portion 100b of the base material 100 is received, the first light intensity distribution is detected.

In this case, because the first light beam S1 is reflected on the flat portion 100b of the base material 100, according to the first intensity distribution, the (height) position on the flat portion 100b of the base material 100 is measured and calculated. Hereupon, herein, the height position shows a position in the Z direction, that is, the position in the advancing direction of the electron beam B.

Further, by the second laser length measuring unit 11ab, the second light beam S2 is irradiated onto the base material 100 from the direction almost perpendicular to the electron beam which is different from the first light beam S1, and when the second light beam S2 transmitting the base material 100 is light received through a pinhole 11c included in the second light receiving section 11bb, the second light intensity distribution is detected.

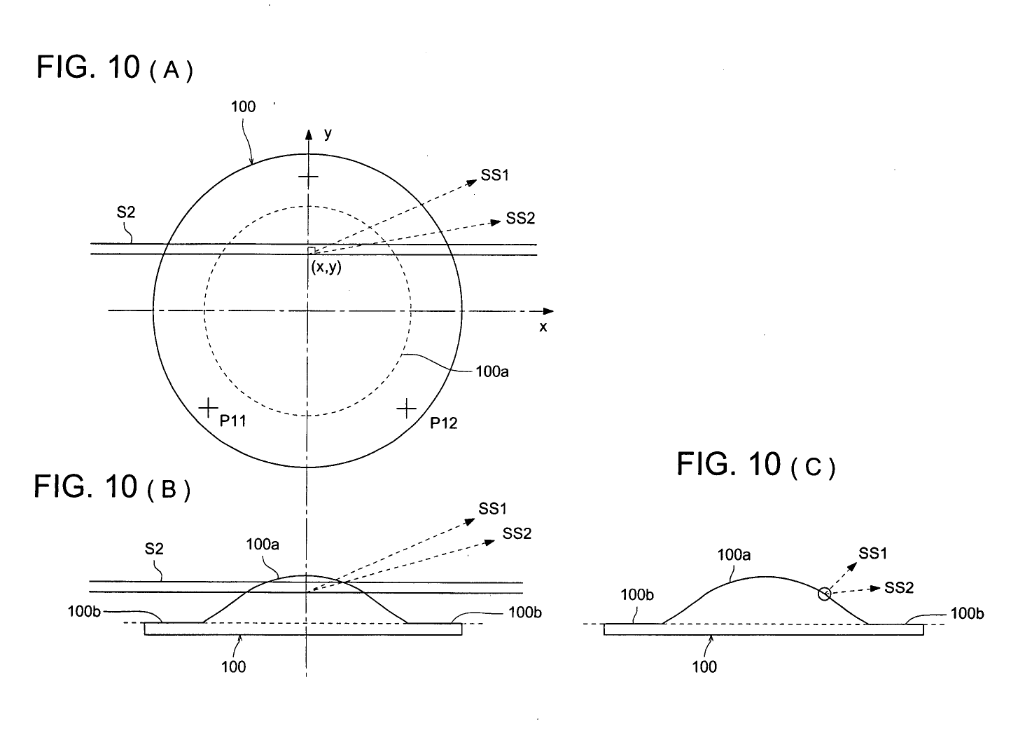

In this case, as shown in FIGS. 10(A) to (c), because the second light beam S2 transmits on the curved surface portion 100a of the base material 100, according to the second intensity distribution, the (height) position on the curved surface portion 100a protruded from the flat portion 100b of the base material 100 is measured and calculated.

In more detail, as shown in FIG. 10(A) to (c), when the second light beam S2 transmits a specific height of a position (x, y) on the curved surface portion 100a in the XY reference coordinate system, in the position (x, y), when the second light beam S2 is projected onto the curved surface of the curved surface portion 100a, the scattered light SS1, SS2 are generated, the light intensity for this scattered light is lowered. In this manner, according to the second light intensity distribution detected by the second light receiving section 11bb, the (height) position on the curved surface portion 100a is measured and calculated.

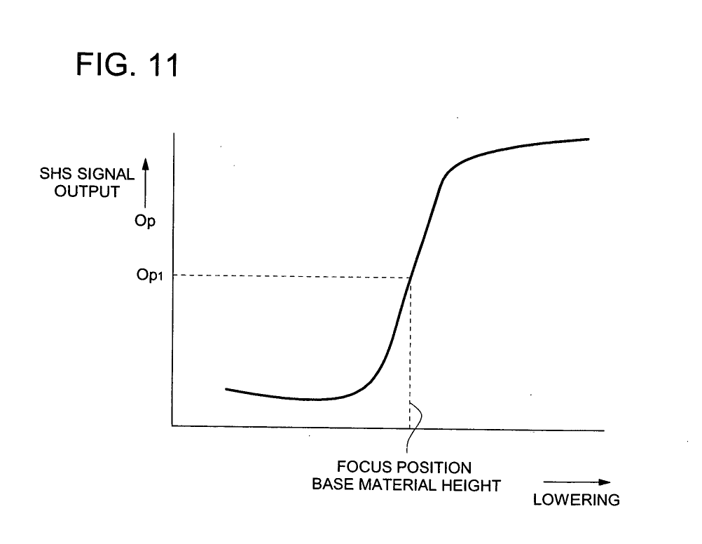

In the case of this calculation, because the signal output of the second light receiving section 11bb has the correlation of the signal output Op with the height of the base material 100 as in the characteristic view shown in FIG. 11, when the characteristic, that is, the correlation table showing the correlation is previously stored in the memory 39 of the control circuit 20, according to the signal output Op in the second light receiving section 11bb, the height position of the base material can be calculated.

Then, this height position of the base material 100 is made as, for example, the depicting position, and the focal position of the electron beam is adjusted and the depicting is conducted.

(Outline of the Principle of the Depicting Position Calculation)

Next, the principle of the depicting position calculation in the electron beam depicting apparatus 1 will be described.

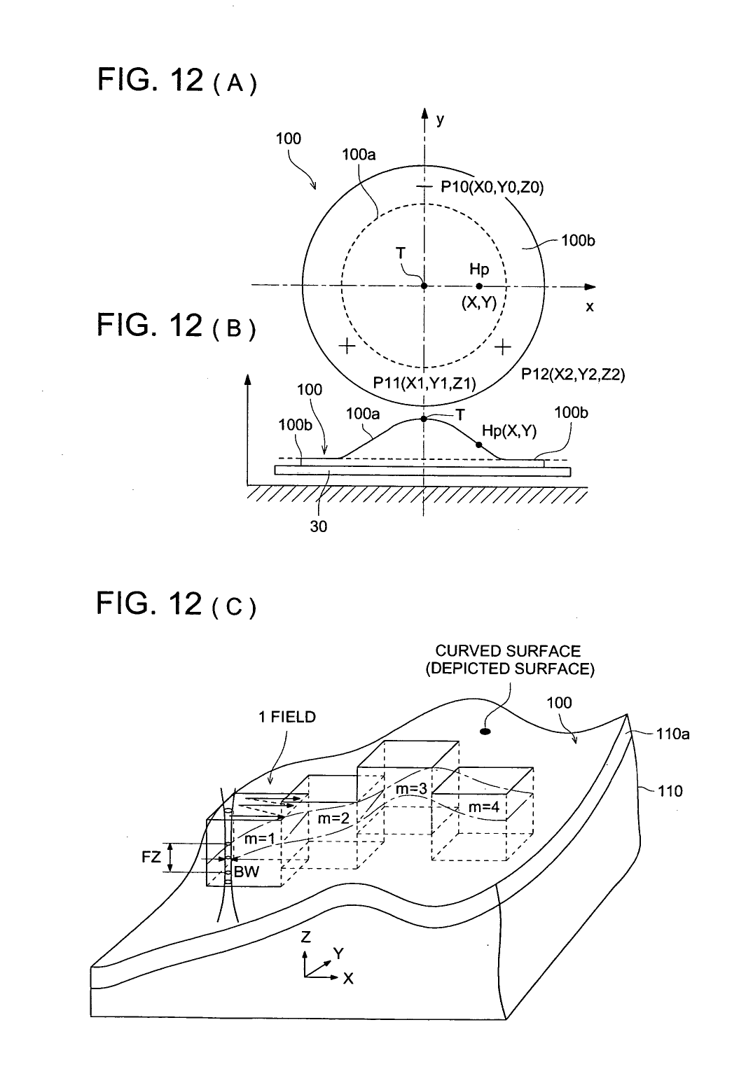

The base material 100 is structured, as shown in FIG. 12(A), (B), by including the flat portion 100b, and the curved surface portion 100a which forms the protruded curved surface from this flat portion 100b. The curved surface of this curved surface portion 100a may be, not limited to the spherical surface, but a free curved surface having the change in all other height directions such as the aspherical surface.

As described above, in the base material 100, before it is placed on the XYZ stage 9, the second mark 111b, for example, the positions of 3 reference points P00, P01, P02 are measured by the shape measuring unit 200. Thereby, for example, the X axis is defined by the reference points P00 and P01, and the Y axis is defined by the reference points P00 and P02, and the first coordinates system in the third dimensional coordinates system is calculated. Herein, the height position in the first coordinates system is defined as H₀(x, y) (the first height position). Thereby, the height position distribution of the base material 2, and the error distribution from its designed value can be calculated.

On the one hand, also after the base material 100 is placed on the XYZ stage 9, the same measuring is conducted. That is, as shown in FIG. 12(A), the second mark 111b on the base material 100, for example, 3 reference points P10, P11, P12 are determined, and by using the measuring apparatus 11, this position is measured. Thereby, for example, the X axis is defined by the reference points P10 and P11, and the Y axis is defined by the reference points P10 and P12, and the second reference coordinates system in the third dimensional coordinates system is calculated.

Further, by these reference points P00, P01, P02, and P10, P11, P12, the coordinate conversion matrix for converting the first reference coordinates system into the second reference coordinates system is calculated, and by using this coordinate conversion matrix, the height position H_{P} (x, y) (the second height position) corresponding to the H₀ (x, y) in the second coordinates system is calculated, and this position is made as the optimum focus position, that is, the depicting position, and the focal position of the electron beam is controlled.

Specifically, as shown in FIG. 12(C), the focal position of the focal depth FZ (beam waist BW=a thinnest part of the beam diameter) of the electron beam is adjusted and controlled to the depicting position in 1 field (m=1) of a unit space in the third dimensional reference coordinates system.

Then, as shown in FIG. 12(C), for example, while shifting in the Y direction in 1 field, when the scanning is successively conducted in the X direction, the depicting in 1 field is conducted. Further, in 1 field, when there is an area, which is not depicted, also for the area, while the control of the focal position is conducted, it is moved in the Z direction, and the depicting processing by the same scanning is conducted.

Next, after the depicting in 1 field is conducted, in also the other field, for example, the field of m=2, and the field of m=3, in the same manner as described above, while the measurement or calculation of the depicting position is conducted, the depicting processing is conducted in the real time. In this manner, when all depicting are completed for the depicting area to be depicted, the depicting processing on the surface of the base material 2 is completed.

Hereupon, a processing program by which the processing such as each kind of calculation processing, measuring processing, control processing as described above is conducted, is previously stored in a program memory 40 as the control program.

(Control System)

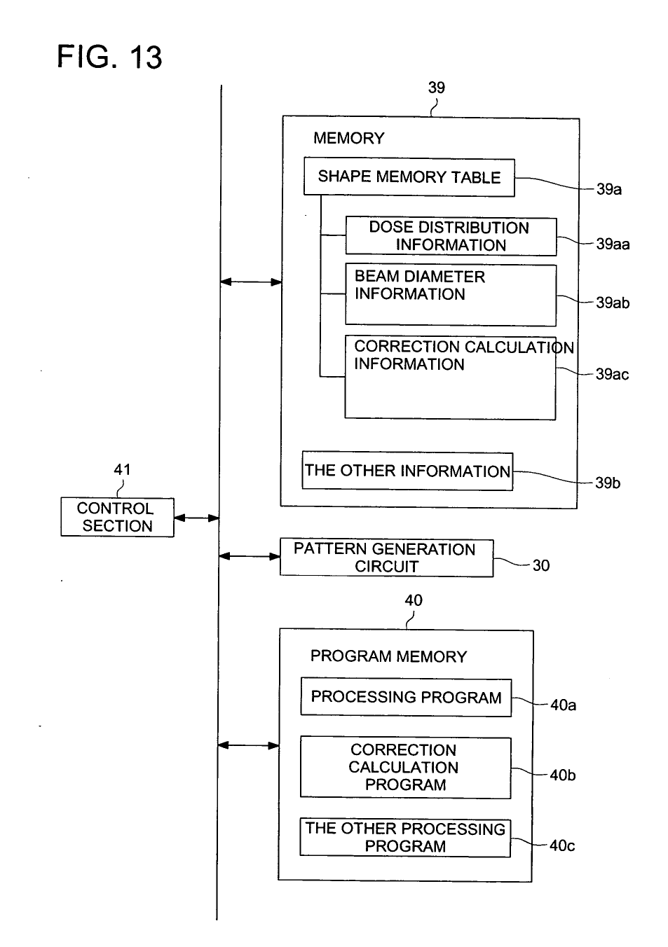

Next, referring to FIG. 13, the structure of the control system in the electron beam depicting apparatus 1 will be described.

As shown in FIG. 13, in a memory 39, a shape memory table 39a is stored, and in this shape memory table 39a, the shape constituting the depicting pattern, for example, the dose distribution information 39aa in which the dose distribution corresponding to each scanning position of the electron beam when the blaze is depicted, is previously defined, or in the same manner, the beam diameter information 39ab in which the beam diameter corresponding to each scanning position of the blaze is previously defined, or the measurement information from the above-described shape measuring apparatus or the film thickness measuring apparatus, specifically, the shape data of the mother optical surface 110a of the raw material 110 of the mother die constituting the base material 100, and the film thickness distribution data of the resist coated on the mother optical surface 110a, and further, the correction calculation information 39ac formed of each of the error distribution data (the error distribution data from the designed value of the height position of the mother optical surface 110a, the error distribution data from the regulated value of the film thickness of the resist coated on the mother optical surface 110a), or the other information 39b is included.

Further, in the program memory 40, the processing program 49a by which the control section 41 conducts the processing which will be described later, or the correction calculation program 40b for adjusting an adjoining interval of the diffraction gratings by which the pattern generating circuit 30 structures the depicting pattern according to the correction calculation information 39ac, for example, for adjusting the adjoining intervals of the blaze ring-shaped zone, or the other processing program 40c is stored.

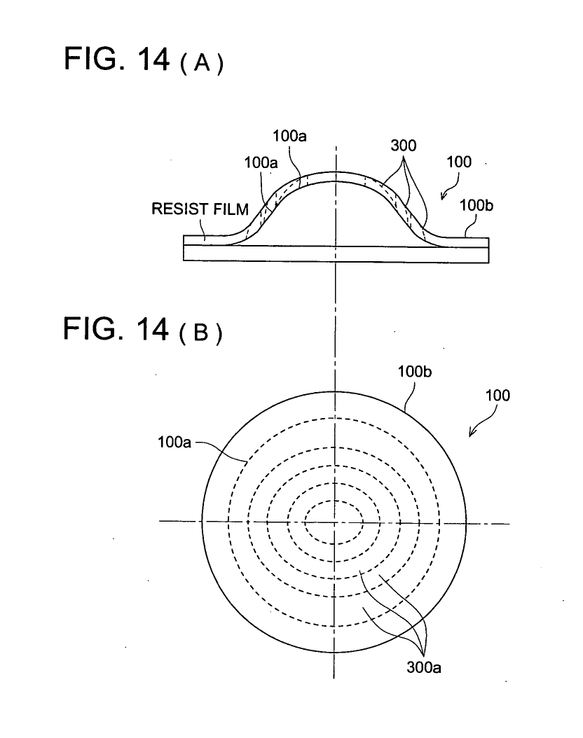

In such a structure, the control section 41 calculates, according to the processing program 40a, based on the dose distribution information 39aa and the beam diameter information 39ab, which is stored in the shape memory table 39a in the memory 39, the shape constituting the depicting pattern, for example, the dose amount corresponding to each scanning position of the blaze 300 shown in FIG. 14(A), and calculates, together with that, the probe current, scanning pitch and the diameter of the electron beam B.

Further, the pattern generating circuit 30 adjusts, according to the correction calculation program 40b, based on the correction calculation information 39ac stored in the shape memory table 39a of the memory 39, as will be described later, the adjoining intervals of diffraction gratings by which the pattern generating circuit 30 structures the depicting pattern, for example, adjusts the adjoining intervals of the blaze ring-shaped zone 300a (the ring-shaped zone by the blaze 300) shown in FIG. 14(B), and makes the shape data of the diffraction structure as the depicting pattern. Hereupon, the pattern generating circuit 30 corresponds to the “depicting adjustment means” of the present invention.

Further, the control section 170 conducts, according to the calculated probe current, scanning pitch and the diameter of the electron beam, the control of the electron gun control section 22, electric field control circuit 29, and lens control section 24. Thereby, the probe current, scanning pitch and diameter of the electron beam B is made adequate, and the diffraction structure as a predetermined depicting pattern is depicted. Hereupon, the control section 170 corresponds to the “control means” of the present invention.

(Detail of the Depicting Adjustment Process)

Herein, the detail of the adjustment process of the depicting pattern by the above-described pattern generating circuit 30 will be described.

The pattern generating circuit 30 makes, initially, based on the correction calculation information 39ac stored in the shape memory table 39a of the memory 39, that is, the error distribution data from the designed value of the height position of the mother optical surface 110a, and the error distribution data from the regulated value of the film thickness of the resist coated on the mother optical surface 110a, the depicted surface which will be the sum of them, that is, the error distribution data from the regulated value of the height position of the curved surface portion 100a surface.

Next, based on the error distribution data from the regulated value of the height position of this curved surface portion 100a surface, that is, the error dt from the regulated value of the height position of the curved surface portion 100a surface, according to the correction calculation program 40b, when the calculation processing which will be described below, is conducted, the correction amount δ_{P} of the interval of the diffraction grating depicted on the curved surface portion 100a surface is calculated.

Herein, when the relationship between the dislocation amount δP of the interval of the diffraction grating depicted on the curved surface portion 100a surface and the phase change X of the diffracted ray is expressed by (expression 1),

$$\begin{matrix}X = - ( m λ / ( p + δ p ) - m λ / p ) \\ = m λ δ p / p2\end{matrix} \qquad ( expression 1 )$$

(Where, δp<<p).

Further, when the relationship between the error dt from the regulated value of the height position of the curved surface portion 100a surface and the phase change X of the diffracted ray is expressed in (expression 2),

X=−(n−1)dt/dr (expression 2).

Where, m: the order of the diffracted ray, λ: wavelength of the light, p: the regulated value of the interval of the diffraction grating, n: refractive index, r: the distance from the center of the base material 100.

When the relational expression is made from these expressions,

dt/dr=mλ/−(n−1)δp/p² (expression 3).

Further, when the dislocation amount δp of the interval of the diffraction grating is introduced from the (expression 3),

δp=−(n−1)p²/mλ×dt/dr (expression 4).

That is, the pattern generating circuit 30 calculates the error dt from the regulated value of the height position of the curved surface 100a surface, and substitutes this into (expression 3), and by the (expression 4), calculates the correction amount δp of the interval of the diffraction grating.

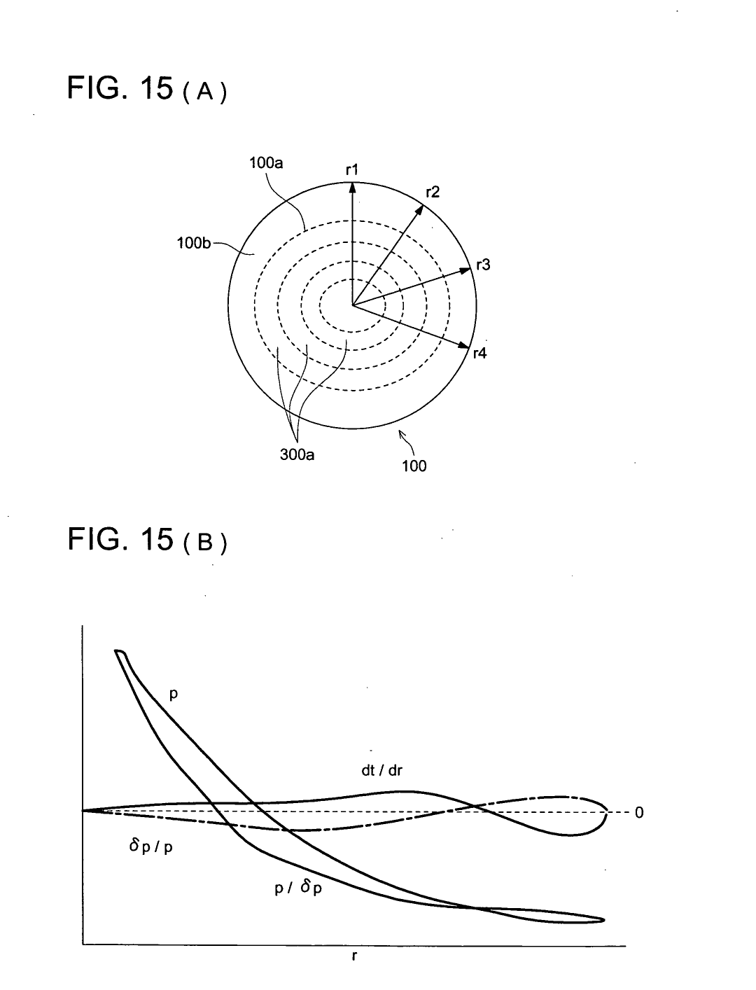

Accordingly, as shown in FIG. 15(A), when, in the position r in the radial direction in an arbitrary line rn (n=1, 2, 3 . . . ), the error dt from the regulated value is generated in the height position of the curved surface portion 100a surface, when the adjustment by which the interval of the diffractive ring-shaped zone 300a is increased or decreased, by δp calculated by the (expression 4) from the regulated value, is conducted, the phase change of the diffracted ray due to the shape error of the curved surface portion 100a can be corrected.

In this case, as shown in, for example, FIG. 15(B), in the position r in the radial direction in an arbitrary line rn of the base material 100, when there is in a tendency that the height position of the curved surface portion 100a is increased to the regulated value, the interval of the diffractive ring-shaped zone of that portion is adjusted to be narrower than the regulated value. Inversely, when there is in a tendency that it is decreased, the interval of the diffractive ring-shaped zone of that portion is adjusted to be wider than the regulated value.

When the diffraction structure adjusted in this manner, is depicted, the processing error (the error from the designed value of the height position of the mother optical surface 110a) in the above-described cutting processing process, and the processing error (the error from the regulated value of the film thickness of the resist coated on the mother optical surface 110a) in the resist film forming process are solved, and the diffraction structure by which a predetermined optical performance can be obtained, can be depicted.

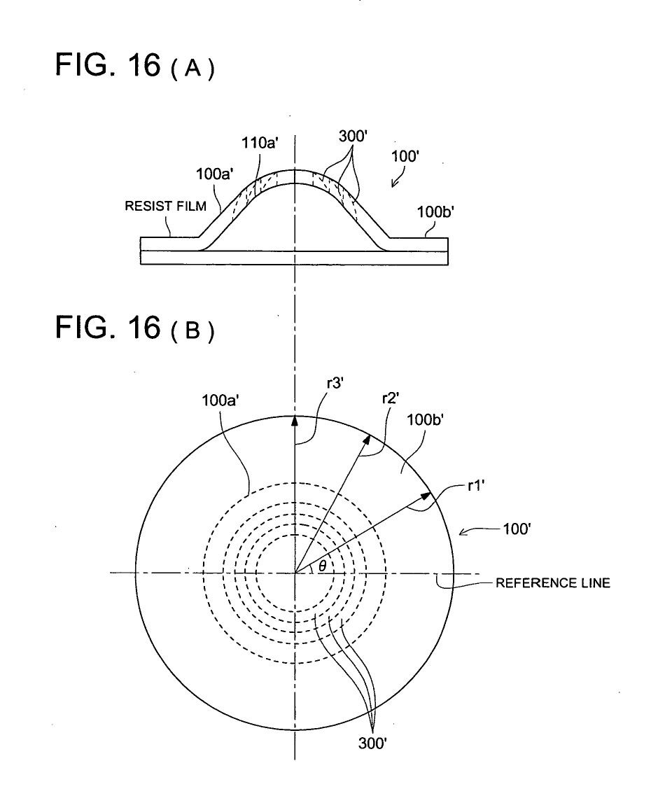

On the one hand, in the second example, the pattern generating circuit 30 makes the shape data off the diffraction structure as the depicting pattern, for example, the shape data of the blaze ring-shaped zone 300a′ (the ring-shaped zone by the blaze 300′) shown in FIG. 16(B).

Further, the control section 41 adjusts, according to the correction calculation program 40b, based on the correction calculation information 39ac stored in the shape memory table 39a of the memory 39, as will be described later, the diffraction grating constituting the depicting pattern, for example, the dose amount when the blaze ring-shaped zone 300a′ shown in FIG. 16(B), is depicted.

Hereupon, the dose amount is the total irradiation amount of the electron beam irradiated per unit area, and the adjustment of the above-described dose amount is conducted under the instruction from the control section 41, when the electron gun control section 22 controls the electron gun power source section 21, and adjusts the current value of the electric power supplied to the electron gun 2 or the voltage value. Alternatively, under the instruction from the control section 41, it is conducted when the electric field control circuit 29 controls the D/A converter 27, and adjusts the scanning speed of the electron beam B which is scanned by the deflection of the deflector 6. Alternatively, it is conducted by the adjustment of both of them. Hereupon, the control section 41 corresponds to the “depicting adjustment means” of the present invention.

Further, the control section 41 controls, based on the calculated probe current, the scanning pitch and the diameter of the electron beam, the electron gun control section 22, electric field control circuit 29 and lens control section 24. Thereby, the probe current when the depicting is conducted, the scanning pitch and the diameter of the electron beam are made adequate, and the diffraction structure as a predetermined depicting pattern is depicted. Hereupon, the control section 41 corresponds to the “control means” of the present invention.

(Detail of the Depicting Adjustment Process)

Herein, the detail of the adjustment processing of the dose amount by the above-described control section 41 in the second example will be described.

The control section 41 makes, initially, based on the correction calculation information 39ac stored in the shape memory table 39a of the memory 39, that is, the error distribution data δt1′ (r, θ), and the error distribution data δt2′ (r, θ) from the regulated value of the film thickness of the resist coated on the mother optical surface 110a′, the depicted surface, that is, the error distribution data δt′(r, θ) from the regulated value of the curved surface portion 100a. Herein, r: the distance from the center of the base material 100, θ: an angle position from the base material 100 (refer to FIG. 16(B)).

The control section 41 calculates, next, based on the error distribution data δt′(r, θ) from the regulated value of the height position of this curved surface portion 100a′ surface, according to the correction calculation program 40b, by conducting the calculation processing which will be described below, the dose when the diffraction grating is depicted on the curved surface portion 100a′, that is, the dose Dm to correct this error distribution.

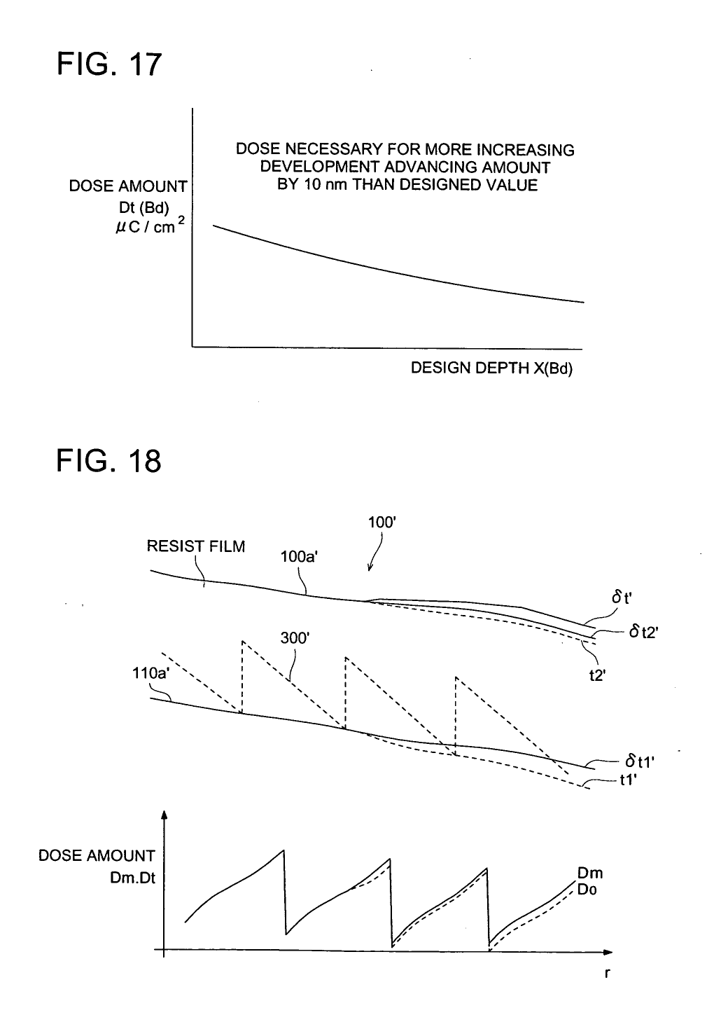

Hereupon, when the relationship between the diffraction grating depicted on the curved surface portion 100a′, for example, the dose Dt(Bd) necessary for the purpose that the development advancing amount (amount of the portion removed by the development processing) of the blaze 300′ shown in FIG. 16(A), is increased by, for example, 10 nm from the designed value, and the depth (designed depth) X (Bd) from the curved surface portion 100a′ surface to give the dose, is expressed by a graph, it is as shown in FIG. 17.

As shown in FIG. 17, generally, the dose Dt(Bd) necessary for increasing the development advancing amount of the blaze to be depicted on the curved surface portion 100a′ has a tendency that, as the depth X from the curved surface portion 100a′ surface of a part onto which the dose is given is increased, it is decreased. However, because such a relationship is different for each of kinds of the diffraction grating, the data relating to them is previously stored as the correction calculation information 39ac in the shape memory table 39a of the memory 39.

Herein, when the dose Dm (r, θ) after the correction is expressed by using this dose Dt(Bd), it is as follows.

Dm (r, θ)=D0 (r, θ)+(δt′ (r, θ)/10)×Dt(Bd) (expression 5)

Herein, D0: the dose as same as the designed value.

That is, the control section 41 calculates the error distribution δt′(r, θ) from the regulated value of the height position of the curved surface portion 100a′, and by substituting it into (expression 5), the dose when the diffraction grating is depicted is added or subtracted by its error amount, from the dose D0 as same as the designed value, and it calculates the dose Dm (r, θ) after correction.

Accordingly, for example, as shown in FIG. 16(B), in the case where the error δt′ from the regulated value is generated in the height position of the curved surface portion 100a′ in the position r′ of the radial direction in an arbitrary line rn′ (n=1, 2, 3 . . . ), when, in place of the dose D0 as same as the designed value, by the dose Dm (r, θ) after the correction calculated by the (expression 5), the diffractive ring-shaped zone 300a′ of the position is depicted, the depicting by which the shape as same as the designed value can be obtained, can be conducted.

In this case, for example, as shown in FIG. 18, when the error δt′(δt1′+δt2′) is larger than 0, that is, a positive value, the dose Dm after correction to depict the part is adjusted so that it is larger than the dose D0 as same as the designed value by the amount to depict the error amount δt′. Inversely, when it is smaller than 0, that is, a negative value, the dose Dm after correction to depict the part is adjusted so that it is smaller than the dose D0 as same as the designed value by the amount to depict the error amount δt′. Herein, t1′: the designed value of the height position of the mother optical surface 110a′, and t2′: the regulated value of the film thickness of the resist coated on the mother optical surface 110a′.

In this manner, when the dose is adjusted, the processing error in the above-described cutting processing process (the error δt1′ from the designed value of the height position of the mother optical surface 110a′), and the processing error in the resist film forming process (the error δt2′ from the regulated value of the film thickness of the resist coated on the mother optical surface 110a′) are solved, and the depicting by which a predetermined diffraction structure and the diffraction grating constituting that (for example, the blaze ring-shaped zone 300a′ and blaze 300′) are obtained, that is, a predetermined optical performance can be obtained, can be conducted.

Returned to FIG. 2 according to the first and second examples, in this manner, after the depicting is conducted by the electron beam depicting apparatus 1, the member E is taken off from the third dimensional stage 9 (step S31).

### The Production Method of the Mother Die: The Third Part

Subsequently, referring to FIG. 3, the production method of the mother die (the third part) will be described along a flow of the flowchart shown in FIG. 2.

<Developing Process>

As shown in FIG. 2, further, by the developing apparatus (not shown in the drawings) the developing processing of the member E is conducted, and the ring-shaped zone like resist is obtained (step S32). Hereupon, when the irradiation time of the electron beam in the same point is made long, because the removal amount of the resist is increased by the degree, in the above-described depicting process, when the irradiation time of the electron beam and the irradiation time (the dose) are adjusted, the resist can be remained so that it is the ring-shaped zone of the blaze.

<Etching Process>

Further, by the etching apparatus (not shown in the drawings) the etching processing of the member E is conducted, the surface of the mother optical surface 110a of the raw material 110 of the mother die is etched, and the blaze like ring-shaped zone 110b (it is depicted more exaggeratively than the actual one) is formed (refer to FIG. 3(e)) (step S33).

By the process up to here, the member E is completed as the mother die.

### Production Method of the Metallic Mold

Next, referring to FIG. 3, the production method of the metallic mold will be described along a flow of the flowchart shown in FIG. 2.

<Electrocasting Process>

As shown in FIG. 2, further, when, in the sulfamine acid nickel bath, the mother die whose surface is actively processed, that is, the member E is dipped, and the current is flowed between the base material 111 and the outside electrode, the elctrocasting 120 is grown (refer to FIG. 3(f)) (step S34). In this case, when the insulating agent is coated on the outer peripheral surface 111f of the base material 111, the electrocasting formation of a part on which the insulating agent is coated, can be suppressed. The elctrocasting 120 forms, in a process of its growth, the optical surface transfer surface 120a accurately corresponding to the mother optical surface 110a, and the ring-shaped zone transfer surface 120b accurately corresponding to the ring-shaped zone 110b.

After that, the data base structured in the computer (not shown in the drawings) is searched based on the ID number NX of the jig 150 corresponding to the member E in processing, and the obtained (that is, used in the cutting processing process) jig 150 is attached to the member E (base material 111) under a predetermined attaching condition (step S35). This predetermined attaching condition is the attaching condition of the first process, and specifically, it means: to match the match mark MX and adjust the phases of the base material 111 and the jig 150, to make the working environmental temperature of ±1.0° C. to the read-out working environmental temperature at the time of tightening (the working environmental temperature at the time of the first process), to tighten the jig 150 by the read out tightening torque (the tightening torque at the time of cutting processing process), and to attach it by using the same bolt 152.

Further, the temperature is made to the working environmental temperature at the time of cutting of the member E in processing, and the outer peripheral surface 111f of the base material 111 is made as the reference, and the member E, the electrocasting 120 and the jig 150 are integrally attached to the chuck in such a manner that the rotating axis of the SPDT processing machine and the optical axis of the member E are aligned, and the outer peripheral surface 120c of the electrocasting 120 is cutting processed (refer to FIG. 3(g)) (step S36).

In addition to that, as shown in FIG. 3(g), a pin hole 120d (center) as the positioning section to the backing member and the screw hole 120e is processed to the electrocasting 120. Hereupon, in place of the pin hole 120d, a cylindrical axis may also be formed. After the processing, the member E, electrocasting 120 and jig 150 are integrally taken off from the SPDT processing machine.

Further, when the electrocasting 120 is integrated with the backing member as will be described below, a movable core 130 is formed (step S37).

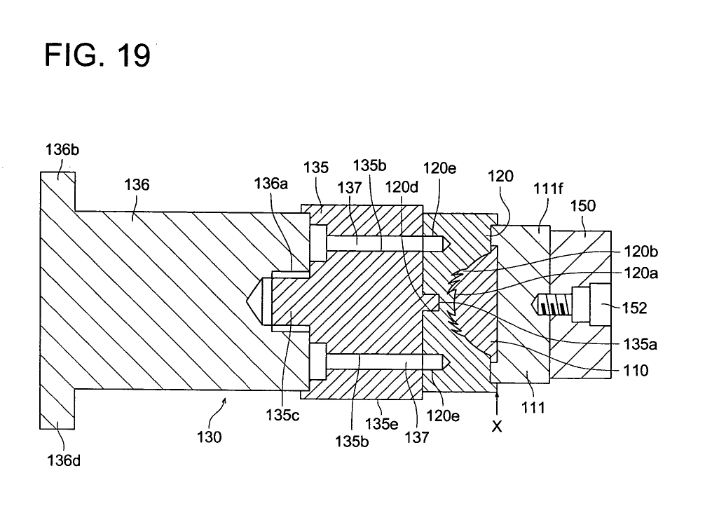

FIG. 19 is a sectional view of the movable core 130 which is shown under the condition that the member E is attached. In FIG. 19, the movable core 130 is structured by the electrocasting 120 arranged on the leading edge (right side in the depicting), a pressing section 136 arranged on the trailing edge (left side in the depicting), and a sliding member 135 arranged between them. The sliding member 135 and pressing section 136 are the backing member.

The electrocasting 120 is positioned under a predetermined relationship with the sliding member 135, when its pin hole 120d is engaged with a pin section 135a protruded from the center of the end surface of the cylindrical sliding member 135, it is positioned with the sliding member 135 under a predetermined relationship, and further, when bolts 137 inserted into 2 bolt holes 135b which pass through the sliding member 135 in parallel with the axis line, are screwed with screw holes 120e, the electrocasting 120 is attached to the sliding member 135.

The sliding member 135 is attached to the pressing section 136 under the predetermined positional relationship when a screw axis 135c which is protruded at the center of the end surface (left end in the view) faced to the end surface (right end in the view) on which the pin section 135a is provided and formed, is screwed with the screw hole 136a formed at the end section of the almost cylindrical pressing section 136. In FIG. 19, a diameter of the outer peripheral surface 135e of the sliding member 135 is larger than the outer peripheral surface of other parts excepting the electrocasting 120 and the flange section 136b of and the pressing section 136. After the sliding member 135 and the pressing section 136 as the backing member are attached, the jig 150 is attached to the chuck of the SPDT processing machine (step S38).

Further, from the database structured in the computer (not shown in the drawings) the temperature is made to the working environmental temperature at the time of cutting of the member E in processing, and further, the outer peripheral surface 111f of the base material 111 is made as the reference, and the outer peripheral surfaces of the sliding member 135 and the pressing section 136 are finished (step S39). For this reason, although the jig 150 is taken off once from the base material 111, the concentricity of the concentric circle pattern (ring-shaped zone 110b) center of the mother die and the center of the metallic mold sliding section outer shape can be obtained within 1 μm. Further, the end surface of the pressing section 136 is cutting processed and the whole length is obtained in the regulated value (step S40).

After that, by cutting at the position shown by an arrow mark X in FIG. 19, from the electrocasting 120 attached to the sliding member 135 and the pressing section 136, the member E and the jig 150 are taken off from the die (step S41). Further, after the electrocasting 120 and the base material 210 are taken off from the die, the elctrocasting 120 of the leading edge of the movable core 130 is finished, and the optical element molding use metallic mold is obtained (step S42).

Through the processes detailed in the foregoing, the metallic mold for molding the optical element could be manufactured.

### Production of the Optical Element

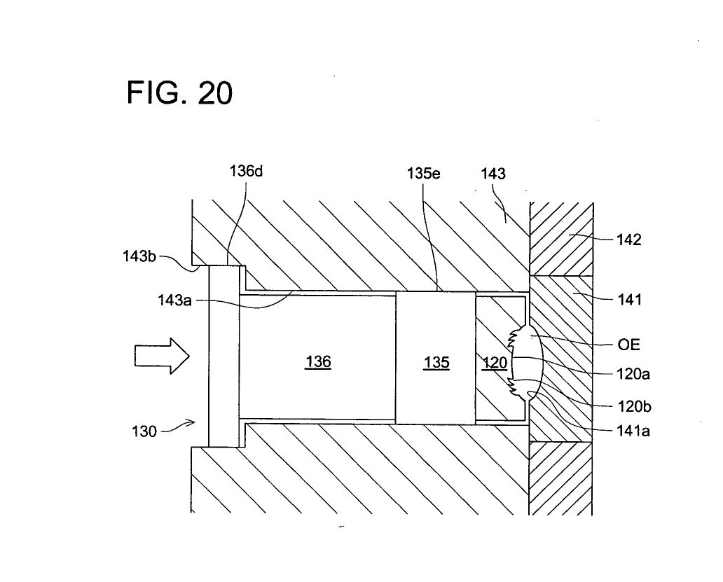

FIG. 20 is a view showing the situation that, by using the movable core 130 formed in such a manner, the optical element is molded. In FIG. 20, a holding section 142 to hold the optical element molding use metallic mold 141 is fixed to a movable side cavity 143. The movable side cavity 143 has a small opening 143a and a large opening 143b coaxial to that. When the movable core 130 is inserted into the movable side cavity 143, an outer peripheral surface 135e of the sliding member 135 slides on an inner peripheral surface of the small opening 143a and an outer peripheral surface 136d of the flange section 136b of the pressing section 136 slides on the inner peripheral surface of the large opening 143b. When guided by such two sliding sections, the movable core 130 can be moved in the axial line direction without largely tilting to the movable side cavity 143.

The resin melted between the optical element molding use metallic mold 141 and the electrocasting 120 is injected, and when the movable core 130 is pressed in the arrow direction, the optical element OE is molded. According to the present embodiment, when the electrocasting 120 as the optical element molding use metallic mold which is accurately transfer-formed from the base material 110 of the mother die is used, the optical surface transfer surface 120a is transfer-formed, and the diffractive ring-shaped zone corresponding to the ring-shaped zone transfer surface 120b is accurately formed concentrically with the optical axis.

Through the processes detailed in the foregoing, the optical element could be produced.

Hereupon, when the optical element molding use metallic mold is processed, because a protrusion (not shown in the drawings) corresponding to the second mark 111b is transfer-formed on the electrocasting 120, when this is used as the reference of the processing, the accurate processing of its outer peripheral surface can also be conducted.

As described above, according to the electron beam depicting method of the present embodiment, the correction to solve the processing errors accumulated in the cutting processing process or the resist film forming process is conducted, and the diffraction structure by which a predetermined optical performance can be obtained, can be depicted.

Hereupon, the depicting method of the base material according to the present invention, and the electron beam depicting apparatus, are described according to its specific embodiment, however, the person skilled in the art can conduct various modifications to the embodiment described in the text of the present invention without departing from the spirit and scope of the present invention.

For example, the measurement information from the shape measuring unit 200 or the film thickness measuring unit is inputted from the measurement information input section 158 of the electron beam depicting apparatus 1, and other than this, it is data-transferred through the network (not shown in the drawings) connected to the control circuit 20, and may also be stored in the memory 39.

Further, the shape measurement of the member E, that is, the measurement of the third dimensional coordinates of the mother optical surface 110a of the raw material 110 of the mother die may be conducted not by the shape measuring unit 200, but by the measuring unit 11 of the electron beam depicting apparatus 1.

Further, after the shape measurement of the member E, the depicting by the electron beam depicting apparatus 1 is conducted at once, and the error of the height position of the mother optical surface 110a of the raw material 110 of the mother die, may be corrected.

Further, the shape measurement of the member E is not conducted, and after the resist is coated on the member E, only the film thickness measurement of the resist film is conducted, and the error of the height position of the mother optical surface 110a of the raw material 110 of the mother die, may be corrected.

As described above, according to the electron beam depicting method according to the present invention, the correction by which the processing errors accumulated in other processes are solved, is conducted, and the diffraction structure by which a predetermined optical performance can be obtained, can be depicted.

Disclosed embodiment can be varied by a skilled person without departing from the spirit and scope of the invention.

What is claimed is:

1. A method for depicting a predetermined diffraction structure on a substrate by scanning an electron beam onto said substrate, comprising the steps of:
measuring a contour of said substrate so as to detect height errors in surface heights in comparison with specified values of a surface height distribution of said substrate;
adjusting a depicting mode for depicting each of diffraction gratings, which constitute said predetermined diffraction structure, in response to said height errors detected in said measuring step, so as to compensate for a phase change of diffracted light caused by each of said height errors corresponding to each of said diffraction gratings; and
depicting each of said diffraction gratings by scanning said electron beam onto said substrate, according to said depicting mode adjusted in said adjusting step.

2. The method of claim 1,
wherein said depicting mode represents each spacing between said diffraction gratings.

3. The method of claim 2,
wherein, in said adjusting step, a space between said diffraction gratings is adjusted to a small value when a concerned error, being one of said height errors, is positive, while a space between said diffraction gratings is adjusted to a large value when a concerned error, being one of said height errors, is negative.

4. The method of claim 1,
wherein said depicting mode represents a dose of said electron beam for depicting each of said diffraction gratings.

5. The method of claim 4,
wherein, in said adjusting step, when a concerned error being one of said height errors is positive, said dose of said electron beam is adjusted to a large value, to such an extent that it is equivalent to an amount for depicting said concerned error, while, when a concerned error being one of said height errors is negative, said dose of said electron beam is adjusted to a small value, to such an extent that it is equivalent to an amount for depicting said concerned error.

6. The method of claim 1,
wherein said contour of said substrate, onto which said diffraction gratings are depicted, is a carved surface.

7. The method of claim 1, further comprising the step of:
measuring a thickness of a resist film formed on said substrate so as to detect thickness errors of said resist film in comparison with specified values of a film thickness distribution of said resist film;
wherein, in said adjusting step, said phase change of said diffracted light, caused by each of said height errors and each of said thickness errors corresponding to each of said diffraction gratings, is compensated for, in response to said height errors and said thickness errors detected in said measuring steps.

8. A method for depicting a predetermined diffraction structure on a substrate by scanning an electron beam onto said substrate, comprising the steps of:
measuring a thickness of a resist film formed on said substrate so as to detect thickness errors of said resist film in comparison with specified values of a film thickness distribution of said resist film;
adjusting a depicting mode for depicting each of diffraction gratings, which constitute said predetermined diffraction structure, in response to said thickness errors detected in said measuring step, so as to compensate for a phase change of diffracted light caused by each of said thickness errors corresponding to each of said diffraction gratings; and
depicting each of said diffraction gratings by scanning said electron beam onto said resist film, according to said depicting mode adjusted in said adjusting step.

9. The method of claim 8,
wherein said depicting mode represents each spacing between said diffraction gratings.

10. The method of claim 9,
wherein, in said adjusting step, a space between said diffraction gratings is adjusted to a small value when a concerned error, being one of said thickness errors, is positive, while a space between said diffraction gratings is adjusted to a large value when a concerned error, being one of said thickness errors, is negative.

11. The method of claim 8,
wherein said depicting mode represents a dose of said electron beam for depicting each of said diffraction gratings.

12. The method of claim 11,
wherein, in said adjusting step, when a concerned error being one of said thickness errors is positive, said dose of said electron beam is adjusted to a large value, to such an extent that it is equivalent to an amount for depicting said concerned error, while, when a concerned error being one of said thickness errors is negative, said dose of said electron beam is adjusted to a small value, to such an extent that it is equivalent to an amount for depicting said concerned error.

13. The method of claim 8,
wherein a contour of said substrate, onto which said diffraction gratings are depicted, is a carved surface.

14. A method for manufacturing a mother die of a mold utilized for molding an optical element having a predetermined diffraction structure, comprising the steps of:
measuring a contour of a substrate, on which said predetermined diffraction structure is depicted, and/or a thickness of a resist film formed on said substrate, so as to detect height errors in surface heights in comparison with specified values of a surface height distribution of said substrate and/or thickness errors of said resist film in comparison with specified values of a film thickness distribution of said resist film;
adjusting a depicting mode for depicting each of diffraction gratings, which constitute said predetermined diffraction structure, in response to said height errors and/or said thickness errors detected in said measuring step, so as to compensate for a phase change of diffracted light caused by each of said height errors and/or each of said thickness errors corresponding to each of said diffraction gratings; and
depicting each of said diffraction gratings by scanning an electron beam onto said resist film formed on said substrate, according to said depicting mode adjusted in said adjusting step.

15. The method of claim 14, further comprising the step of:
cutting a material so as to create said substrate from said material.

16. The method of claim 14, further comprising the steps of:
forming said resist film on said substrate; and
developing said resist film, on which said diffraction gratings are depicted in said depicting step, to create said mother die having said predetermined diffraction structure.

17. The method of claim 14, further comprising the step of:
etching said mother die created in said developing step.

18. A mother die of a mold utilized for molding an optical element having a predetermined diffraction structure, said mother die being manufactured by a method comprising the steps of:
measuring a contour of a substrate, on which said predetermined diffraction structure is depicted, and/or a thickness of a resist film formed on said substrate, so as to detect height errors in surface heights in comparison with specified values of a surface height distribution of said substrate and/or thickness errors of said resist film in comparison with specified values of a film thickness distribution of said resist film;
adjusting a depicting mode for depicting each of diffraction gratings, which constitute said predetermined diffraction structure, in response to said height errors and/or said thickness errors detected in said measuring step, so as to compensate for a phase change of diffracted light caused by each of said height errors and/or each of said thickness errors corresponding to each of said diffraction gratings; and
depicting each of said diffraction gratings by scanning an electron beam onto said resist film formed on said substrate, according to said depicting mode adjusted in said adjusting step.

19. A method for manufacturing mold utilized for molding an optical element having a predetermined diffraction structure, said mold being manufactured from a mother die and said predetermined diffraction structure being transferred to said mold from said mother die by applying electrocast processing, said mother die being manufactured by a method comprising the steps of:
measuring a contour of a substrate, on which said predetermined diffraction structure is depicted, and/or a thickness of a resist film formed on said substrate, so as to detect height errors in surface heights in comparison with specified values of a surface height distribution of said substrate and/or thickness errors of said resist film in comparison with specified values of a film thickness distribution of said resist film;
adjusting a depicting mode for depicting each of diffraction gratings, which constitute said predetermined diffraction structure, in response to said height errors and/or said thickness errors detected in said measuring step, so as to compensate for a phase change of diffracted light caused by each of said height errors and/or each of said thickness errors corresponding to each of said diffraction gratings; and
depicting each of said diffraction gratings by scanning an electron beam onto said resist film formed on said substrate, according to said depicting mode adjusted in said adjusting step

20. A mold utilized for molding an optical element having a predetermined diffraction structure, said mold being manufactured from a mother die and said predetermined diffraction structure being transferred to said mold from said mother die by applying electrocast processing, said mother die being manufactured by a method comprising the steps of:
measuring a contour of a substrate, on which said predetermined diffraction structure is depicted, and/or a thickness of a resist film formed on said substrate, so as to detect height errors in surface heights in comparison with specified values of a surface height distribution of said substrate and/or thickness errors of said resist film in comparison with specified values of a film thickness distribution of said resist film;
adjusting a depicting mode for depicting each of diffraction gratings, which constitute said predetermined diffraction structure, in response to said height errors and/or said thickness errors detected in said measuring step, so as to compensate for a phase change of diffracted light caused by each of said height errors and/or each of said thickness errors corresponding to each of said diffraction gratings; and depicting each of said diffraction gratings by scanning an electron beam onto said resist film formed on said substrate, according to said depicting mode adjusted in said adjusting step.

21. An optical element, molded by utilizing a mold and having a predetermined diffraction structure, said mold being manufactured from a mother die and said predetermined diffraction structure being transferred to said mold from said mother die by applying electrocast processing, said mother die being manufactured by a method comprising the steps of:
measuring a contour of a substrate, on which said predetermined diffraction structure is depicted, and/or a thickness of a resist film formed on said substrate, so as to detect height errors in surface heights in comparison with specified values of a surface height distribution of said substrate and/or thickness errors of said resist film in comparison with specified values of a film thickness distribution of said resist film;
adjusting a depicting mode for depicting each of diffraction gratings, which constitute said predetermined diffraction structure, in response to said height errors and/or said thickness errors detected in said measuring step, so as to compensate for a phase change of diffracted light caused by each of said height errors and/or each of said thickness errors corresponding to each of said diffraction gratings; and
depicting each of said diffraction gratings by scanning an electron beam onto said resist film formed on said substrate, according to said depicting mode adjusted in said adjusting step.

22. An apparatus for depicting a predetermined diffraction structure on a substrate by scanning an electron beam onto said substrate, comprising:
an electron-beam scanning section, that includes an electron-beam irradiating device to irradiate said electron beam and an electron-beam deflecting device to deflect said electron beam irradiated by said electron-beam irradiating device, to scan said electron beam onto said substrate;
a contour measuring section to measure a contour of said substrate so as to detect height errors in surface heights in comparison with specified values of a surface height distribution of said substrate;
a depicting-mode adjusting section to adjust a depicting mode for depicting each of diffraction gratings, which constitute said predetermined diffraction structure, in response to said height errors detected by said contour measuring section, so as to compensate for a phase change of diffracted light caused by each of said height errors corresponding to each of said diffraction gratings; and
a controlling section to control said electron-beam scanning section so as to depict each of said diffraction gratings by scanning said electron beam onto said substrate, according to said depicting mode adjusted by said depicting-mode adjusting section.

23. The apparatus of claim 22,
wherein said depicting mode represents each spacing between said diffraction gratings.

24. The apparatus of claim 23,
wherein said depicting-mode adjusting section adjusts a space between said diffraction gratings to a small value when a concerned error, being one of said height errors, is positive, while adjusts a space between said diffraction gratings to a large value when a concerned error, being one of said height errors, is negative.

25. The apparatus of claim 22,
wherein said depicting mode represents a dose of said electron beam for depicting each of said diffraction gratings.

26. The apparatus of claim 25,
wherein, when a concerned error being one of said height errors is positive, said depicting-mode adjusting section adjusts said dose of said electron beam to a large value, to such an extent that it is equivalent to an amount for depicting said concerned error, while, when a concerned error being one of said height errors is negative, said depicting-mode adjusting section adjusts said dose of said electron beam to a small value, to such an extent that it is equivalent to an amount for depicting said concerned error.

27. An apparatus for depicting a predetermined diffraction structure on a substrate by scanning an electron beam onto said substrate, comprising:
an electron-beam scanning section, that includes an electron-beam irradiating device to irradiate said electron beam and an electron-beam deflecting device to deflect said electron beam irradiated by said electron-beam irradiating device, to scan said electron beam onto said substrate;
a film-thickness measuring section to measure a thickness of a resist film formed on said substrate so as to detect thickness errors of said resist film in comparison with specified values of a film thickness distribution of said resist film;
a depicting-mode adjusting section to adjust a depicting mode for depicting each of diffraction gratings, which constitute said predetermined diffraction structure, in response to said thickness errors detected by said film-thickness measuring section, so as to compensate for a phase change of diffracted light caused by each of said thickness errors corresponding to each of said diffraction gratings; and
a controlling section to control said electron-beam scanning section so as to depict each of said diffraction gratings by scanning said electron beam onto said resist film, according to said depicting mode adjusted by said depicting-mode adjusting section.

28. The apparatus of claim 27,
wherein said depicting mode represents each spacing between said diffraction gratings.

29. The apparatus of claim 28,
wherein said depicting-mode adjusting section adjusts a space between said diffraction gratings to a small value when a concerned error, being one of said thickness errors, is positive, while adjusts a space between said diffraction gratings to a large value when a concerned error, being one of said thickness errors, is negative.

30. The apparatus of claim 27,
wherein said depicting mode represents a dose of said electron beam for depicting each of said diffraction gratings.

31. The apparatus of claim 30,
wherein, when a concerned error being one of said thickness errors is positive, said depicting-mode adjusting section adjusts said dose of said electron beam to a large value, to such an extent that it is equivalent to an amount for depicting said concerned error, while, when a concerned error being one of said thickness errors is negative, said depicting-mode adjusting section adjusts said dose of said electron beam to a small value, to such an extent that it is equivalent to an amount for depicting said concerned error.
